(19) United States
(12) Patent Application Publication
(10) Pub. No.: US 2025/0375731 A1
(43) Pub. Date: Dec. 11, 2025

(54) CARBON DIOXIDE CAPTURE SYSTEMS, DEVICES, AND METHODS

(71) Applicant: Carbon Blade Corporation, San Diego, CA (US)

(72) Inventors: Moez Nulwala, San Diego, CA (US); Edward McMahon, San Diego, CA (US); Hunaid Nulwala, San Diego, CA (US); Sriram Valluri, San Diego, CA (US)

(21) Appl. No.: 18/875,407

(22) PCT Filed: Jun. 16, 2023
(86) PCT No.: PCT/US2023/068632

§ 371 Date: Dec. 16, 2024

Related U.S. Application Data
(60) Provisional application No. 63/352,636, filed on Jun. 16, 2022.

(51) Int. Cl. B01D 53/18; B01D 53/14; B01D 53/62; B01D 53/78; B01D 53/96

(52) U.S. Cl. CPC B01D 53/185; B01D 53/1425; B01D 53/1475; B01D 53/1493; B01D 53/62; B01D 53/78; B01D 53/965; B01D 2251/304; B01D 2251/604; B01D 2257/504; B01D 2258/06

(57) ABSTRACT

Blades, devices, systems, and methods for carbon dioxide capture are provided. In various embodiments, the carbon dioxide capture device may include blades or blade modules stacked in a column and configured to undergo a rotary motion to cause or facilitate a capture solution to flow on the blades through gaps formed by an air-permeable layers. Carbon dioxide-containing air may penetrate through the air-permeable layers and get in contact with the capture solution such that carbon dioxide in the air may be captured by reacting with the capture solution.

### CROSS-REFERENCE TO RELATED APPLICATIONS

This patent document claims priority to and benefits of U.S. Provisional Patent Application No. 63/352,636 entitled “PASSIVE DIRECT AIR CONTACTOR DESIGN FOR CO₂ REMOVAL” filed on Jun. 16, 2022. The entire content of the aforementioned patent application is incorporated by reference as part of the disclosure of this patent document.

### TECHNICAL FIELD

This patent document relates to systems, devices and techniques for carbon dioxide capture, and in particular passive and self-powered carbon dioxide capture systems, devices, and methods for removing carbon dioxide from air at room temperature.

### BACKGROUND

Carbon dioxide capture is a technology and process of capturing carbon dioxide from various sources including, e.g., atmospheric air, air or exhaust gas from industrial processes and power generation. Carbon dioxide capture may contribute to mitigate carbon dioxide (CO2) emissions and therefore plays an influential role in efforts to combat climate change and reduce greenhouse gas emissions.

### SUMMARY

The technology disclosed in this document can be implemented to provide methods, devices, and systems for carbon dioxide capture, and in specific configurations, the disclosed technology may be used for passively capturing carbon dioxide from air by allowing direct contact of carbon-dioxide containing air with a capture solution and implemented as a stand-alone modular system that is configured to operate at room temperature, self-powered, and convenient to scale up or down.

One aspect of the present document relates a carbon dioxide capture device. The carbon dioxide capture device may include a blade configured to undergo a rotary motion around a rotation axis, in which the blade may include a support base, an inlet, an outlet, and an air-permeable layer. In some embodiments, the support base and the air- permeable layer collectively form a gap through which a capture solution flows, driven by the rotary motion of the blade, between the inlet and the outlet, the support base includes a plurality of surface features configured to cause or facilitate the capture solution to distribute on the support base while the capture solution flows through the gap, the air-permeable layer is configured to allow air to enter the gap and contact the capture solution, and the capture solution is configured to extract carbon dioxide in the air while the capture solution flows through the gap. The carbon dioxide capture device may further include a capture solution storage device configured to store the capture solution, an inlet assembly in fluid communication with the blade via the inlet of the blade and configured to feed the capture solution from the capture solution storage device to the blade through the inlet of the blade, an outlet assembly in fluid communication with the blade via the outlet of the blade and configured to guide the capture solution leaving the blade via the outlet of the blade to return to the capture solution storage device, and a rotation assembly configured to cause the rotary motion of the blade.

A second aspect of the present document relates to a direct-air-capture (DAC) system. The DAC system may include a carbon dioxide capture device. In some embodiments, the DAC system of example B1 includes a blade configured to undergo a rotary motion around a rotation axis, the blade including a support base, an inlet, an outlet, and an air-permeable layer, in which: the support base and the air-permeable layer collectively forming a gap through which a capture solution flows, driven by the rotary motion of the blade, between the inlet and the outlet, the support base includes a plurality of surface features configured to distribute the capture solution across the support base while the capture solution flows through the gap, the air-permeable layer is configured to allow air to enter the gap and contact the capture solution, and the capture solution is configured to extract carbon dioxide in the air by converting the carbon dioxide to an aqueous salt while the capture solution flows through the gap. The DAC system may further include a capture solution storage device configured to store the capture solution, an inlet assembly in fluid communication with the blade via the inlet of the blade and configured to feed the capture solution from the capture solution storage device to the blade through the inlet of the blade, an outlet assembly in fluid communication with the blade via the outlet of the blade and configured to guide the capture solution leaving the blade via the outlet of the blade to return to the capture solution storage device, and a rotation assembly configured to cause the rotary motion of the blade, and an electrodialysis bipolar membrane (EDBM) device configured to regenerate a used capture solution that includes the aqueous salt and/or a used stripping solution. For example, in some implementations, the capture solution reacts with an acid to form a salt; and the salt then is passed through the EDBM device to regenerate the capture solution and the acid.

A third aspect of the present document relates to a DAC system. The DAC system may include a plurality of carbon dioxide capture devices of any one of examples described herein, an electrodialysis bipolar membrane (EDBM) device configured to regenerate the capture solution that includes an aqueous salt generated by a reaction between the carbon dioxide extracted from the air by the plurality of carbon dioxide capture devices and the capture solution, and a power assembly configured to provide power to operate the DAC system such that the DAC system is self-powered.

A fourth aspect of the present document relates to a blade. The blade may include a support base, an inlet, an outlet, and an air-permeable layer, in which the blade is configured to undergo a rotary motion around a rotation axis, the support base and the air-permeable layer collectively form a gap through which a capture solution flows, driven by the rotary motion of the blade, between the inlet and the outlet, the support base includes a plurality of surface features configured to cause or facilitate the capture solution to distribute on the support base while the capture solution flows through the gap, the air-permeable layer is configured to allow air to enter the gap and contact the capture solution, and the capture solution is configured to extract carbon dioxide in the air while the capture solution flows through the gap.

A fifth aspect of the present document relates to a blade. The blade may include a support base, an inlet, an outlet, and an air-permeable layer, in which the blade is configured to undergo a rotary motion around a rotation axis, the inlet and the outlet are positioned on opposite ends of a diagonal of the support base, the support base has a first edge and a second edge that are on opposite sides of the diagonal of the support base and at an angle with each other, the support base and the air-permeable layer collectively form a gap through which a capture solution flows, driven by the rotary motion of the blade, between the inlet and the outlet, the support base includes a plurality of surface features configured to cause or facilitate the capture solution to distribute on the support base while the capture solution flows through the gap, the plurality of surface features including a first group that includes at least one first ridge or wall substantially parallel to the first edge, a second group that includes at least one second ridge or wall substantially parallel to the second edge, a third group that includes at least one third ridge or wall substantially perpendicular to the diagonal of the support base, a fourth group that includes at least one fourth ridge or wall at an oblique angle with the first edge or the second edge, and a fifth group that includes at least one fifth ridge or wall of a substantially semi-circle shape, or a portion thereof, the air-permeable layer is configured to allow air to enter the gap and contact the capture solution, and the capture solution is configured to extract carbon dioxide in the air while the capture solution flows through the gap.

The above and other aspects of the disclosed technology and their implementations and applications are described in greater detail in the drawings, the description and the claims.

### BRIEF DESCRIPTION OF THE DRAWINGS

FIG. 1A shows a diagram of an example embodiment of a carbon dioxide capture device in accordance with the present technology.

FIG. 1B shows a schematic of an example carbon dioxide capture device according to some embodiments of the present document.

FIG. 1C shows a cross sectional view of the example carbon dioxide capture device of FIG. 1B.

FIGS. 2A through 2C illustrate schematics of an example blade segment according to some embodiments of the present document.

FIGS. 2D through 2H illustrate results of example simulations of a fluid flow over a surface with surface features according to some embodiments of the present document.

FIGS. 3A and 3B illustrate an example inlet pipe according to some embodiments of the present document.

FIGS. 4A through 4D illustrate example inlet pipes and an example capture solution storage device according to some embodiments of the present document.

FIG. 5 illustrates an example outlet pipe according to some embodiments of the present document.

FIG. 6 illustrates an example wind cup according to some embodiments of the present document.

FIG. 7 illustrates an example method for carbon dioxide capture and sequestration according to some embodiments of the present document.

FIG. 8 illustrates an example carbon dioxide capture system according to some embodiments of the present document.

FIGS. 9A through 9J illustrate schematics of an example carbon dioxide capture device and components thereof according to some embodiments of the present document.

It is understood that the drawings are not to scale. Like reference numerals indicate like components.

### DETAILED DESCRIPTION

The technology disclosed in this document can be implemented to provide methods, devices, and systems for carbon dioxide capture, and in specific configurations, the disclosed technology may be used for passively capturing carbon dioxide from air (e.g., atmospheric air, carbon dioxide-laden air resulting from an industrial process, power generation, or another source that contains an elevated amount of carbon dioxide than the atmospheric air) by allowing direct contact of pre-capture air with a fluidic solution, referred to as a “capture solution,” that is configured to extract carbon dioxide by reaction. In some embodiments, the carbon dioxide capture device as disclosed herein includes a blade. The blade may include a support base and an air-permeable layer that collectively form a gap through which the capture solution flows.

Air that contains carbon dioxide (e.g., pre-capture air) may penetrate through the air-permeable layer of the blade to contact the capture solution such that a reaction (sometimes referred to herein as a “capture reaction”) may occur between the capture solution and carbon dioxide in the air to extract the carbon dioxide from the air. The capture reaction in which the capture solution includes NaOH may be illustrated in formula (1):

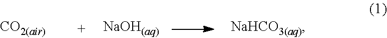

in which the subscript “aq” stands for aqueous. Formula (1) is one example of a capture reaction, and other chemical reactions to remove CO₂ from air can be utilized by the carbon dioxide capture device. Other example capture solutions may include, such as, KOH, LiOH, Na₂CO₃, K₂CO₃, or a combination thereof.

In some embodiments, the air-permeable layer may be impermeable to the capture solution such that the capture solution remains within the gap and does not leak through the air-permeable layer while the capture solution flows through the gap, thereby reducing the energy needed to drive the flow. In some embodiments, the air-permeable layer may include a hydrophobic material to reduce the resistance for the flow of the capture solution through the gap. The blade may be configured to undergo a rotary motion so that the capture solution may flow, driven by the rotary motion of the blade, between an inlet and an outlet of the blade, thereby obviating a need to use an electrically powered rotor or the energy consumption associated with the use of such a rotor. In some embodiments, the support base may include a plurality of surface features (e.g., ridges and/or walls of one or more orientations and/or shapes) to cause or facilitate the capture solution to distribute (e.g., substantially evenly) on the support base or body to enhance the contact between the capture solution and the air, thereby improving the carbon dioxide capture. For example, it is important for the capture solution to spread out in the gap of the blade to promote a higher refresh rate along a greater surface area, i.e., a higher refresh rate leads to more CO2 captured faster. Also, for example, in addition to directing flow of the capture solution in the gap between the support and the porous membrane, the surface features (e.g., ridges and/or walls) of the blade can also support the height of the gap. Additionally or alternatively, the rotary motion may enhance the spreading of the air flow over the surface of the blade to facilitate the carbon dioxide capture. In some embodiments, a substantially even distribution of the capture solution on the support base or body may indicate presence of one or more of the characteristics, including but not limited to that the entire gap (between the air-permeable layer and support base or body) is filled with the capture solution, that the flow rate of the capture solution in the gap is below a flow rate threshold, that a difference in the flow rate of the capture solution in the gap is below a variation threshold, or the like, or a combination thereof. In some implementations, for example, the capture solution can be a liquid or aqueous fluid, and in some implementations, for example, the capture solution can be a gaseous fluid. Additionally or alternatively, the carbon dioxide capture may be improved by stacking multiple blades in the carbon dioxide capture device such that the surface area of the air-capture solution contact is increased.

In some embodiments, the rotary motion of the blade(s) may be driven by renewable energy. For example, the carbon dioxide capture device may include a wind cup configured to harvest wind power to drive the rotary motion of the blade(s). As another example, the carbon dioxide capture device may include a power assembly configured to harvest power derived from a natural source and convert it to, e.g., electricity, a mechanical energy (e.g., driving a rotary motion of the blade segments 115 or 115B), thereby creating a minimal or substantially no additional carbon footprint. The power assembly may include, e.g., a wind turbine, a solar panel, a power storage device configured to store power generated but not used yet for future use, or the like, or a combination thereof. The power generated by the power assembly may support the operation of the carbon dioxide capture device including, e.g., driving the rotary motion of the blade(s), driving one or more pumps in or operably connected to the carbon dioxide capture device such that the carbon dioxide capture device is self-powered, obviating the need to equip the carbon dioxide capture device with an additional power supply and therefore simplifying the setup and transportation, and reducing the cost of the carbon dioxide capture device.

In some embodiments, the capture solution may include a metal hydroxide (e.g., NaOH, KOH, LiOH, or a combination thereof) solution, and the reaction between the capture solution and carbon dioxide may generate a salt (or referred to as, for brevity, a capture salt including, e.g., sodium carbonate (Na₂CO₃), sodium bicarbonate (NaHCO₃), potassium bicarbonate (KHCO₃)). Examples of the capture solution may include NaOH, KOH, LiOH, Na₂CO₃, K₂CO₃, or a combination thereof. The capture solution containing the capture salt may be re-used for carbon dioxide capture until its pH value reaches or exceeds a pH threshold. As used herein, the capture solution containing the capture salt whose pH value reaches or exceeds the pH threshold may be referred to as the used or saturated capture solution. In some embodiments, the carbon dioxide capture device 100 (e.g., the device 100B, 100C) may include a pH sensor interfaced with the capture solution in the gap. In some embodiments, the used capture solution containing the capture salt may be fed to a carbon dioxide stripping unit where the captured carbon dioxide may be stripped or separated from the used capture solution by reacting with a stripping solution (e.g., sulfuric acid (H₂SO₄), or another acid) (referred to as a stripping reaction as exemplified in formula (2), resulting in separated carbon dioxide and a used stripping solution containing a second salt (or referred to as a stripping salt for brevity).

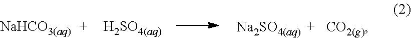

in which the subscript “g” stands for gas.

In some embodiments, the carbon capture system may include a regeneration device including an electrodialysis bipolar membrane (EDBM) where a regeneration reaction using the used stripping solution (or referred to as a regeneration reaction for brevity) may proceed to generate a renewed capture solution and a renewed stripping solution. The regeneration reaction may be exemplified in formula (3):

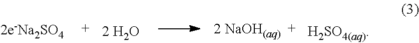

The EDBM-based regeneration reaction according to embodiments of the disclosed technology may consume much less energy (e.g., 1 to 1.5 MJ/Kg CO₂) than other existing procedures including, e.g., thermal regeneration systems that may involve an amine solution for solvent regeneration and consume approximately 3.5-4 MJ/Kg CO₂. Accordingly, the EDBM-based regeneration device may significantly lower the energy consumption in the carbon dioxide capture system as disclosed herein.

In some embodiments, the carbon dioxide capture device may include or be in fluid connection with a capture solution storage device for storing the capture solution. The carbon dioxide capture device may include an inlet assembly configured to feed the capture solution to the blade(s) and an outlet assembly configured to guide the capture solution exiting the blade(s) to return to the storage device. The carbon dioxide capture device may include or be in fluid connection with a stripping solution storage device for storing the stripping solution. The carbon dioxide capture device, or a system including the carbon dioxide capture device, may operate as a substantially closed system in terms of the capture solution and/or the stripping solution such that the need to replenish the capture solution and/or the stripping solution is minimal. In combination with the power assembly, the carbon dioxide capture device, or a system including the carbon dioxide capture device, as disclosed herein, may operate as a stand-alone device or system, and be portable to a desired location for carbon dioxide capture conveniently. In addition, the carbon dioxide capture device, or a system including the carbon dioxide capture device, as disclosed herein, may be scaled up or down conveniently by adding or removing the blades in the carbon dioxide capture device, by adding or removing one or more carbon dioxide capture device in a system, or a combination thereof. The carbon dioxide capture device, or a system including the carbon dioxide capture device, as disclosed herein, may capture carbon dioxide with pre-capture air as an input and post-capture air with a reduced amount of carbon dioxide as an output, without generating an environmentally unfriendly substance or impact.

In some embodiments, the carbon dioxide system or device as disclosed herein may be used to capture carbon dioxide at a location adjacent or remote from where the carbon dioxide is generated, and thereby generating a carbon credit based on a net amount of the carbon dioxide captured. The carbon credit may be saved or traded with a third party. In some embodiments, the carbon dioxide system or device as disclosed herein may be added to or integrated with an existing or new system that produces carbon dioxide as part of its function and process in order to capture CO₂ emitted at the source, e.g., such as a factory, a machine, etc., such that the carbon dioxide system or device is configured to reduce or eliminate CO₂ emissions by the existing or new carbon dioxide producing system.

These and other example embodiments of the carbon dioxide capture devices, systems, and methods in accordance with the disclosed technology are described in further detail below.

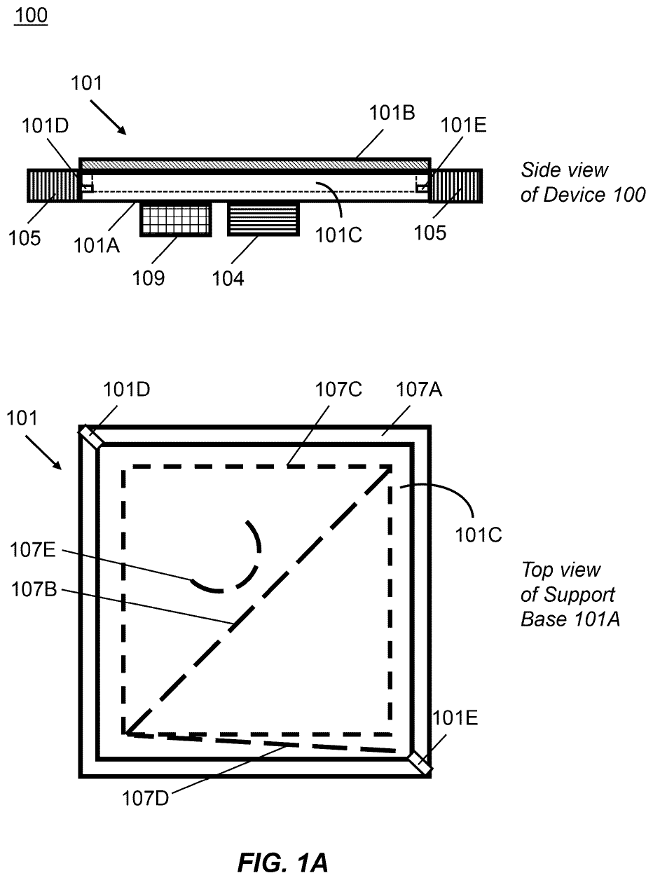

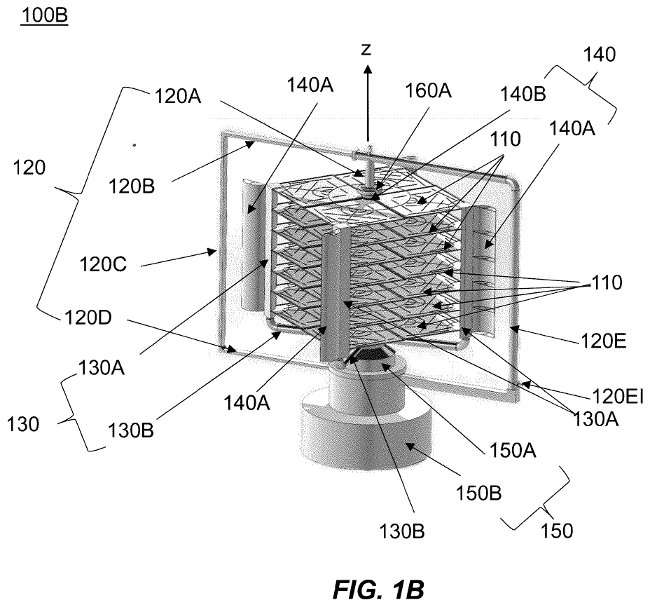

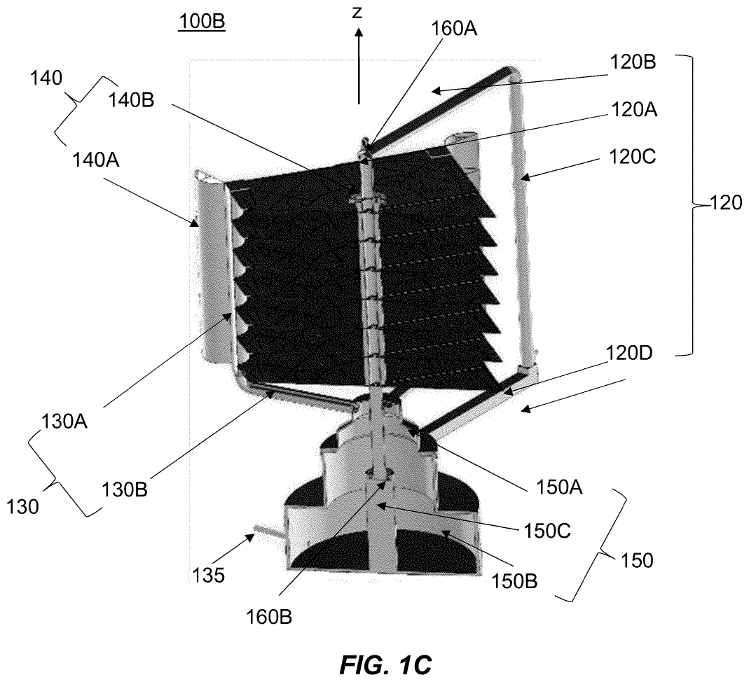

FIG. 1A shows a diagram of an example embodiment of a carbon dioxide capture device 100 in accordance with the present technology. The carbon dioxide capture device 100 includes at least one blade 101. The blade 101 may include a support base 101A and an air-permeable layer 101B coupled to the support base 101A so as to form a space or gap 101C, through which a capture solution can be contained and can flow. Air containing carbon dioxide is intaken through the air-permeable layer 101B of the blade 101 to contact the capture solution so that a capture reaction may occur between the capture solution and carbon dioxide in the air to extract the carbon dioxide from the air. The support base 101A and air-permeable layer 101B can be configured in a variety of shapes and sizes, including but not limited to a rectangle, square, circle, ellipse, triangle, or other geometry. In some embodiments, the blade 101 may include an inlet 101D comprising an opening (which may include a cover to close/seal the opening) to inflow the capture solution through the support base 101A into the space or gap 101C; and in some embodiments, the blade 101 may include an outlet 101E having an opening (which may include a cover to close/seal the opening) to outflow the capture solution through the support base 101A out of the space or gap 101C. In some embodiments, the height of the space or gap 101C may be in a range of 0.1 mm to 3 mm, or in a range of 0.2 mm to 3 mm. In some embodiments of the blade 101, for example, the inlet 101D and/or outlet 101E may be a respective opening in a portion of the support base 101A; whereas, in some example embodiments, the inlet 101D and/or the outlet 101E may include a component that interfaces with a respective opening of the support base 101A, e.g., a tube, a channel, or other component that leads to/from the opening.

In various embodiments of the carbon dioxide capture device 100, for example, the blade 101 can be configured as one or multiple blade segments. The blade 101 illustrated in the top view of FIG. 1A depicts the blade 101 including one blade segment. Other example embodiments of the blade 101 can include a plurality of blade segments, such as FIG. 1B showing multiple blades 110 vertically arranged above/below another, where each blade 110 includes four blade segments coupled together in a single horizontal plane. In some embodiments, blade segments may be coupled together by a mechanical coupling mechanism (e.g., screw, pin, latch, lock, overlapping indentations, etc.), welding, or adhesion (e.g., glue); and in some embodiments, the blade segments can be fabricated as a single blade, e.g., by injection molding or other fabrication process. This and other embodiments of the blade 101 including blade segments are discussed in further detail below.

Referring to the top view in FIG. 1A, in some embodiments, the support base 101A may include a one or more surface features 107 (e.g., ridges and/or walls having one or more orientations and/or shapes). For example, a ridge can include a structure that protrudes from a surface of the support base 101A to a distance that does not contact the air-permeable layer 101B; and a wall can include a structure that protrudes from a surface of the support base 101A to a distance that contacts the air-permeable layer 101B. In some embodiments, for example, the one or more surface features 107 can include a perimeter 107A disposed around the side(s) of the support base 101A. In some embodiments, for example, the one or more surface features 107 can include a first ridge(s) or wall(s) 107B disposed within the space or gap 101C that is/are configured to be substantially perpendicular to a line between the inlet 101D and the outlet 101E. In some embodiments, for example, the one or more surface features 107 can include a second ridge(s) or wall(s) 107C disposed within the space or gap 101C that is/are configured to be substantially parallel to edge(s) of the support base 101A. In some embodiments, for example, the one or more surface features 107 can include a third ridge(s) or wall(s) 107D disposed within the space or gap 101C that is/are configured to be at an oblique angle with the edge(s) of the support base 101A. In some embodiments, for example, the one or more surface features 107 can include a fourth ridge(s) or wall(s) 107E disposed within the space or gap 101C that is/are configured to be a substantially curved shape (e.g., semi-circle shape), or a portion thereof. It is noted that the top view drawing in FIG. 1A is for illustrative purposes and is not drawn to scale or depict precise orientations, spacing, and/or quantity of the ridge(s) or wall(s).

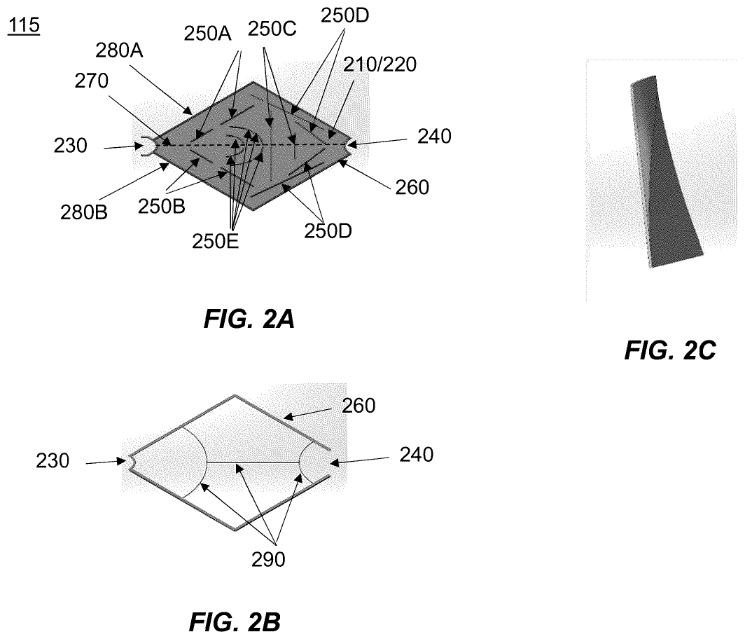

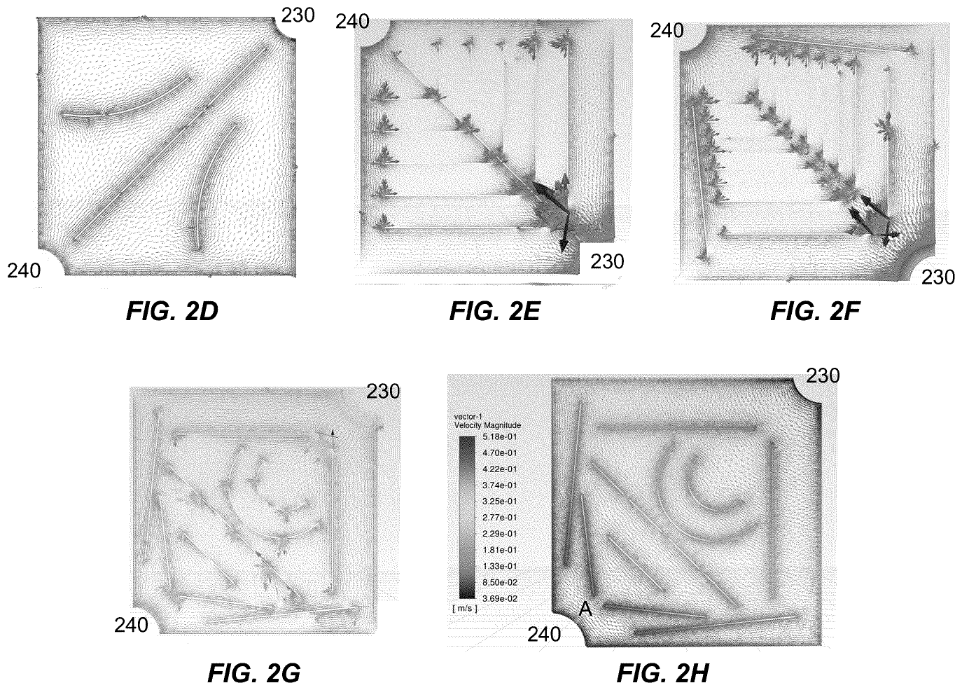

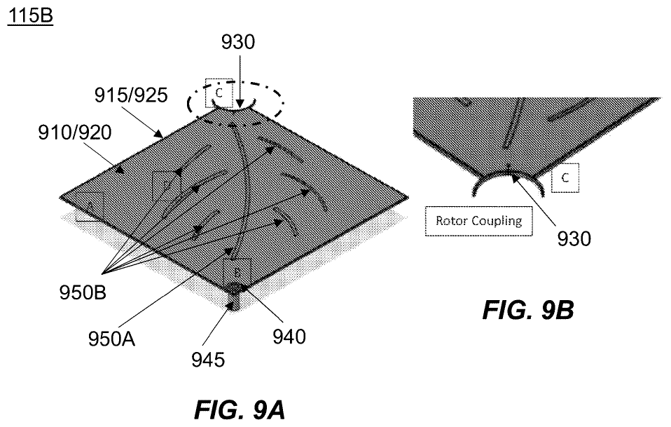

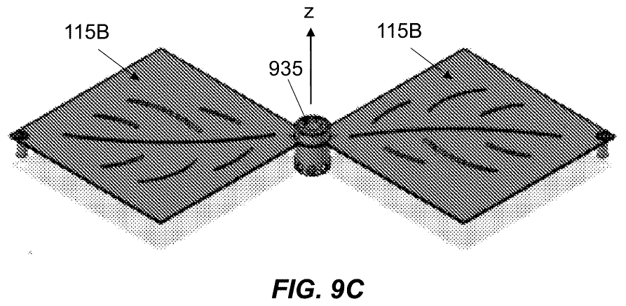

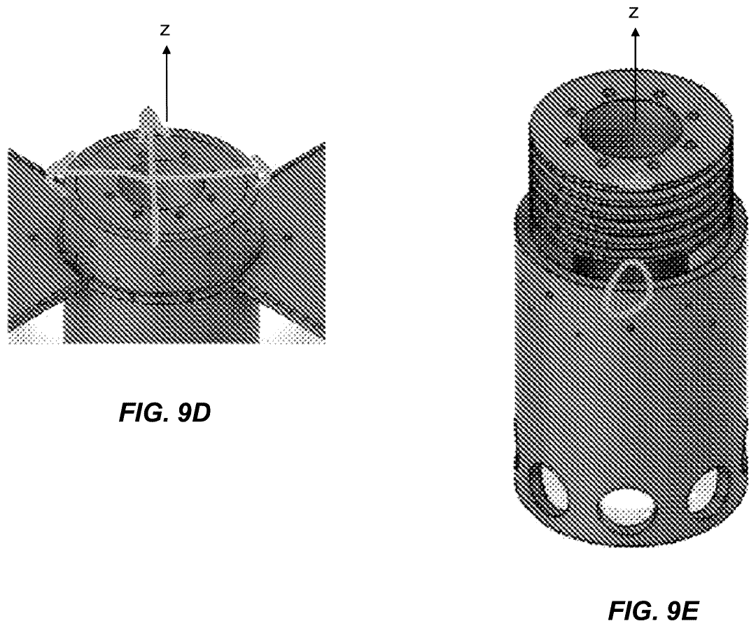

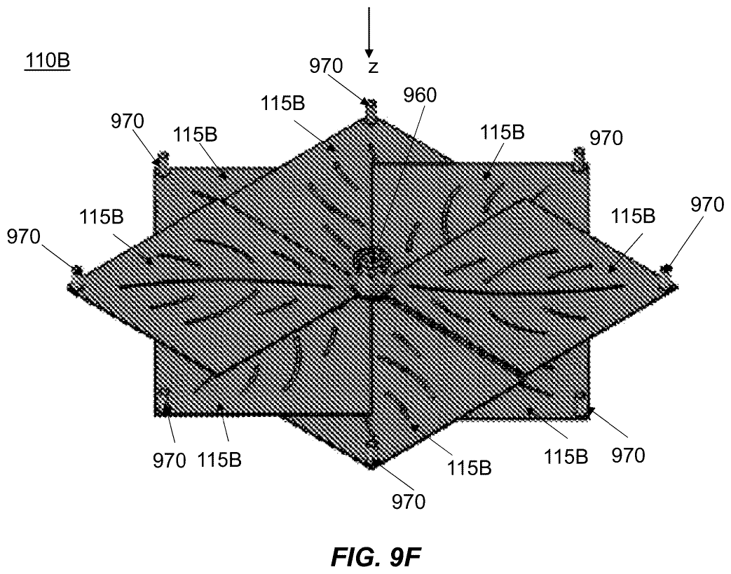

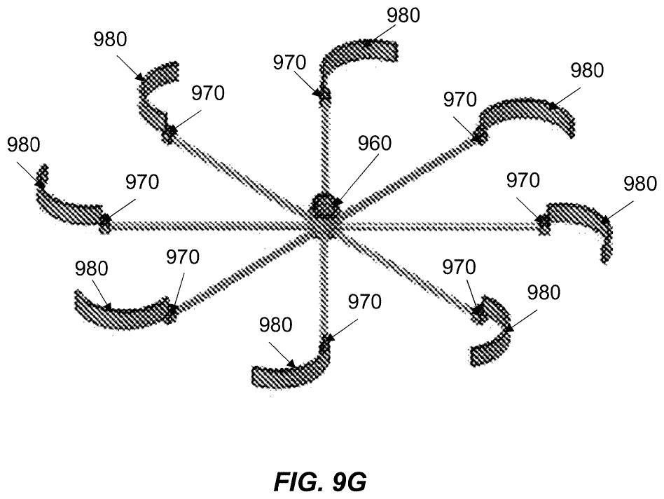

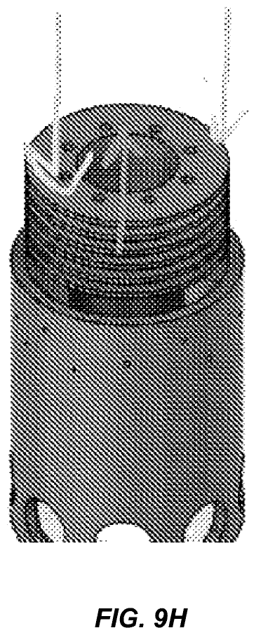

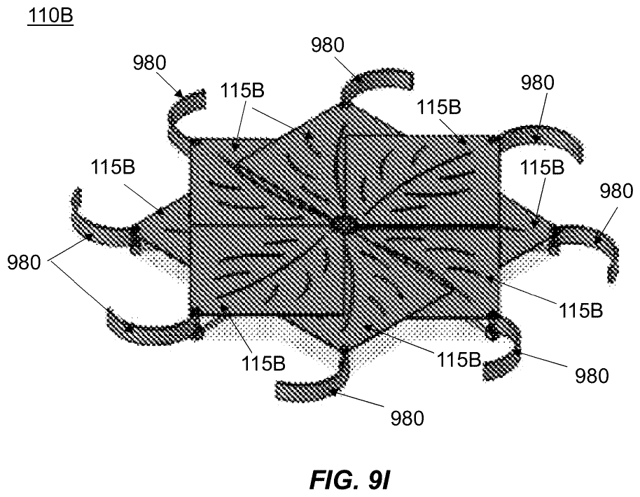

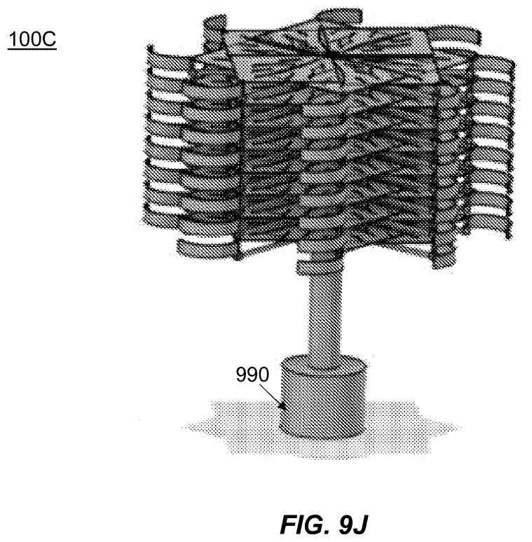

In some embodiments, the plurality of surface features (e.g., ridges and/or walls of one or more orientations and/or shapes) may be configured to cause or facilitate the capture solution to distribute (e.g., substantially evenly) on the support base 101A to enhance the contact between the capture solution and the air, thereby improving the carbon dioxide capture. Various embodiments of the support base 101A of a blade are illustrated later for example embodiments of a blade 101 (or individual blade segment(s)), such as support base 210 in FIG. 2A and support base 910 in FIG. 9A, for example. Additionally or alternatively, the plurality of surface features 107 may be configured to prevent the air-permeable layer 101B from sagging such that the gap 101C partially or entirely collapses. Various embodiments of the plurality of surface features 107 are illustrated later for example embodiments of the blade 101 (or individual blade segment(s)), such as ridges and/or walls 250A through 250E of one or more orientations and/or shapes as illustrated in FIG. 2A, and ridges and/or walls 950A and 950B of one or more orientations and/or shapes as illustrated in FIG. 9A.

Referring back to the side view in FIG. 1A, in some embodiments of the carbon dioxide capture device 100, for example, the carbon dioxide capture device 100 may include a rotation assembly 104 coupled to the support base 101A of the blade 101 to control movement (e.g., rotation) of the blade 101, which can facilitate and control the flow of the capture solution within the space or gap 101C, driven by the rotary motion of the blade, between the inlet 101D and the outlet 101E of the blade 101, thereby obviating a need to use an electrically powered rotor (and the energy consumption associated with the use of such a rotor). In some implementations, for example, the rotation assembly 104 can include a wind cup, a sail, or other component that can convert energy received by impeding external airflows to movement of the carbon dioxide capture device 100, or a portion thereof. For example, in some embodiments, the rotation assembly 104 includes a rotational axis (not shown in FIG. 1A) so that the blade 101 can rotate with respect to the axis. The blade 101 may be configured to rotate both clockwise and anticlockwise, depending on the direction of the wind at the time of operation. In some implementations, the blade 101 of the carbon dioxide capture device 100 can rotate at 1to 2 rpm (rotations per minute).

In some embodiments, the carbon dioxide capture device 100 may include a capture solution storage device 105 to store capture solution and supply capture solution to the space or gap 101C of the blade 101. In some embodiments, for example, the capture solution storage device 105 can include one or more pipes, tubes, channels or other connectors or conduits to feed the capture solution from the storage compartment to the blade 101.

In some embodiments, the carbon dioxide capture device 100 can include a data processing device 109, which includes at least one processor and at least one memory, to process data associated with the device 100, such as control signals, detection signals, and/or communication signals. In some embodiments of the data processing device 109, for example, the data processing device 109 can include a processor to process data and a memory in communication with the processor to store and/or buffer data. In various embodiments, for example, the processor can include one or multiple processors, and the memory can include one or multiple memory units. For example, the processor can include a central processing unit (CPU), a microcontroller unit (MCU), a graphics processing unit (GPU), or other type of processor. For example, the memory can include and store processor-executable code, which when executed by the processor, configures the data processing device 109 to perform various operations, e.g., such as receiving information, commands, and/or data, processing information and data, and transmitting or providing information/data to another device. To support various functions of the data processing device 109, the memory can store information and data, such as instructions, software, values, images, and other data processed or referenced by the processor. For example, various types of random access memory (RAM) devices, read only memory (ROM) devices, flash memory devices, and other suitable storage media can be used to implement storage functions of the memory. In some embodiments, the data processing device 109 includes an input/output (I/O) unit to interface the processor and/or memory to other modules, units or devices, e.g., associated with an external device, such as a wireless communications device, a remote computing device, and/or other external devices. In some embodiments, data processing device 109 includes a wireless communications unit, e.g., such as a transmitter (Tx) or a receiver (Rx), or a transmitter-receiver (transceiver or Tx/Rx). In some embodiments of the data processing device 109, for example, the processor, the memory, and/or the I/O unit is in communication with the wireless communications unit. For example, in such embodiments, the I/O unit can interface the processor and memory with the wireless communications unit, e.g., to utilize various types of wireless interfaces compatible with typical data communication standards, which can be used in communications of the data processing device 109 with other devices. The data communication standards include, but are not limited to, Bluetooth, Bluetooth Low Energy (BLE), Zigbee, IEEE 802.11, Wireless Local Area Network (WLAN), Wireless Personal Area Network (WPAN), Wireless Wide Area Network (WWAN), WiMAX, IEEE 802.16 (Worldwide Interoperability for Microwave Access (WiMAX)), 3G/4G/LTE/5G/6G cellular communication methods, and parallel interfaces. In some implementations, the data processing device 109 can interface with other devices using a wired connection via the I/O unit. The data processing device 109 can also interface with other external interfaces, sources of data storage, and/or visual or audio display devices, etc. to retrieve and transfer data and information that can be processed by the processor, stored in the memory, or exhibited on an output unit, such as a display (e.g., monitor, speaker, force feedback, etc.). For example, in some embodiments, the data processing device 109 can include one or more data processing devices 109, which can be embodied on one or more of a circuit board, microcontroller, or a computer or mobile computing device (e.g., smartphone, tablet, etc.).

In some embodiments, the carbon dioxide capture device 100 (may include a pH sensor (not shown) interfaced with the capture solution in the space or gap 101C. For example, the pH sensor can be disposed on a surface of the support base 101A and in communication with the data processing device 109.

In some example embodiments, for example, the carbon dioxide capture device 100 can include multiple blades 101 and/or multiple blade segments, e.g., such that the surface area of the air-capture solution contact is increased. FIG. 1B discussed below illustrates an embodiment of the carbon dioxide capture device 100 that includes multiple blades 101 arranged vertically, where each blade 101 comprises a plurality of blade segments.

FIG. 1B shows a schematic of an example embodiment of the carbon dioxide capture device 100 of FIG. 1A, shown in FIG. 1B as carbon dioxide capture device 100B. FIG. 1C shows a cross sectional view of the example carbon dioxide capture device 100B of FIG. 1B. As shown in FIGS. 1B and 1C, the carbon dioxide capture device 100B may include a plurality of example embodiments of the blade 101 (shown as blades 110), an inlet assembly 120, an outlet assembly 130, an example embodiment of rotation assembly 104 (shown as rotation assembly 140), and an example embodiment of capture solution storage device 105 (shown as capture solution storage device 150).

The blades 110 may be configured to allow direct contact between air and the capture solution such that carbon dioxide in the pre-capture air may be captured or extracted by reacting with the capture solution. In some embodiments, like that illustrated in the diagram of FIG. 1B, at least some blades of the plurality of blades 110 may be arranged substantially equidistantly along the rotation axis z. In some embodiments, the distance between neighboring blades of at least some of the plurality of blade segments 115 may be in a range of 3 mm to 8 mm, or at least 1 mm, or at least 2 mm, or at least 3 mm, or at least 4 mm, or at least 5 mm, or approximately 3 mm, or approximately 4 mm, or approximately 5 mm, or approximately 6 mm, or approximately 7 mm, or approximately 8 mm, or smaller than 100 mm, or smaller than 80 mm, or smaller than 60 mm, or smaller than 50 mm, or smaller than 40 mm, or smaller than 20 mm, or smaller than 10 mm. In other embodiments (not shown), for example, at least some of the blades 110 may be substantially parallel to each other. In some embodiments, for example, two or more blade segments of a blade 110 may be substantially parallel or configured in the same plane, i.e., at least the support base of the blade segments align in the same horizontal plane. In some embodiments, at least two of the blade segments of the blades 110 may be at an oblique angle with each other. The blades 110 (and/or blade segments) may be configured to undergo a rotary motion around the rotation axis z. The rotation axis z may substantially coincide with a center of each of at least some blade segments of the blades 110. In some embodiments, the rotary motion of the blades 110 (and/or blade segments) may be driven by wind power harvested by wind cups 140A of the rotation assembly 140. As illustrated in FIG. 1B, the blades 110 (and, in some instances, their respective blade segments) may be rotatably coupled to an inlet pipe 120A of the inlet assembly 120 via, e.g., a bearing 160A. In some embodiments, the rotary motion of at least some of the blades 110 may be substantially synchronized. Merely by way of example, the blades 110 (and, in some instances, their respective blade segments) may be connected to each other by way of all being coupled to the same inlet pipe 120A and/or the same drainage pipes 130A as described elsewhere in the present disclosure. As illustrated in the diagram of FIG. 1B, the carbon dioxide capture device 100B may include seven blades 110 each including multiple (e.g., four) blade segments. It is understood that the number of blades 110 and/or blade segments of a respective blade 110, as described in this and other portions of the patent disclosure, is for illustration purposes and not intended to be limiting. For example, the carbon dioxide capture device 100B may include one blade 110 that includes a single blade segment; or the carbon dioxide capture device 100B may include one blade 110 that includes multiple blade segments (e.g., two, three, four, five, six, seven, eight, etc.); or the carbon dioxide capture device 100B may include two or more blades 110, where at least one blade has a single blade segment and/or where at least one blade has multiple blade segments. More descriptions regarding the blades 110, blade segments, and/or portions thereof, may be found elsewhere in the present document. See, e.g., FIGS. 2A, 2B (regarding blade segment 115), and 9A through 9J (regarding blade segment 115B), and the description thereof.

The surface area of the blade 110 available for, e.g., air-capture solution contact provided by one blade segment or multiple blade segments, as described elsewhere in the present document, may be in a range of 100 cm² to 250,000 cm². For example, the surface area may be at least 100 cm², or at least 200 cm², or at least 300 cm². The surface area for air-capture solution contact provided by the carbon dioxide capture device 100B may be increased by stacking multiple blades 110. The surface area for air-capture solution contact provided by a stack or column of blades 110 in the carbon dioxide capture device 100B may relate to one or more factors including the surface area of the respective blade 110 (and/or blade segment(s)), and the count of blade segments and/or count of the blades in the stack or column. For example, the height of the carbon dioxide capture device 100B may be in a range from 0.1 meters to 2 meters. The carbon dioxide capture device 100B may include a blade stack or column including, e.g., at least 5, or at least 10, or at least 20, or at least 40, or at least 50, or at least 50, or at least 60, or at least 80, or at least 100, or at least 120, or at least 150, or at least 200 blades 110 and/or blade segments. Merely by way of example, the carbon dioxide capture device 100B may include 10 to 250 blades 110 and/or blade segments stacked in a column. The surface area for air-capture solution contact provided by the carbon dioxide capture device 100B may in a range of 100 cm² to 250,000 cm². For example, the surface area for air-capture solution contact provided by the carbon dioxide capture device 100B may be at least 500 cm², or at least 800 cm², or at least 1,000 cm², or at least 1,500 cm², or at least 2,000 cm², or at least 3,000 cm², or at least 5,000 cm².

In some embodiments, the blade 110 may include one or more blade segments (e.g., one, two, three, four, five, six, seven, eight blades). For example, a blade 110 as illustrated in FIG. 1B may include four, five, six, eight, or more blade segments (e.g., blade segment 115 as illustrated in FIG. 2A, or blade segment 115B as illustrated in FIG. 9A). As another example, one blade may include one blade segment similar to the blade segment 115 or 115B as illustrated, where the inlet and outlet are on opposing corners or edges of the respective support base. As a further example, one blade may include one blade segment similar to the blade segment 115 or 115B as illustrated, except that an inlet 230 is located in a center of the blade and an outlet 240 is located on a perimeter of the blade (e.g., at one or more corners or vertexes of a blade having the shape of a polygon (e.g., a square, a rectangle, or another type of polygon). In some embodiments, the carbon dioxide capture device 100B may include a plurality of blades 110 arranged in multiple blade segments as illustrate in FIG. 1B. In some embodiments, the inlets of the blade segments of each of the blades 110 may be located at a substantially same level along the rotation axis (e.g., from the surface where the carbon dioxide capture device 100B is placed), and/or the outlets of the blade segments of each of the blades 110 may be located at a substantially same level along the rotation axis (e.g., from the surface where the carbon dioxide capture device 100B is placed). In some embodiments, the rotation axis z may substantially coincide with a center of each of at least some of the plurality of blades 110.

The inlet assembly 120 may include inlet pipes 120A through 120E. The inlet assembly 120 may be in fluid communication with each of one or more of the blades 110 via an inlet (e.g., 230 as illustrated in FIGS. 2A and 2B) of the blade 110 and configured to feed the capture solution from the capture solution storage device 150 to the blade 110 through the inlet of the blade. The inlet pipes 120A through 120E may form a conduit for feeding the capture solution from the capture solution storage device 150 to the blades 110. For example, the capture solution may leave the capture solution storage device 150 through the inlet pipe 120D and move toward the inlet pipe 120A through the inlet pipe 120C and/or the inlet pipe 120E, and then the inlet pipe 120B. In some embodiments, the inlet pipe 120A may include a plurality of inlet slits each of which may be fluidly coupled to the inlet of one of one or more blades (e.g., blade segments 115, 115B of the blades 110) so that the capture solution may flow from the inlet pipe 120A to a blade 110 via the inlet slit(s) and the fluidly coupled inlet of the blade 110. For example, the inlets of the blade segments of the blades 110 may correspond or are fluidly coupled to an inlet slit of the inlet pipe 120A. As another example, an inlet slit of the inlet pipe 120A may include separate orifices each of which may correspond or be fluidly coupled to one of the inlets of the blade segments of a respective blade 110. The inlet pipe 120A, 120C, and 120E may be substantially parallel to the rotation axis z. The inlet pipe 120B and 120D may be substantially perpendicular to the rotation axis z. It is understood that the orientation of any one of the inlet pipes 120A through 120E as described is provided for illustration purposes and not intended to be limiting. Merely by way of example, the outlet pipe 120B may be perpendicular to or at an oblique angle with the rotation axis z. As another example, the inlet pipes 120A, 120C, and 120E may be substantially parallel to each other, or at least two of the inlet pipes 120A, 120C, and 120E may be at an oblique angle with each other. The flow of the capture solution within the inlet assembly 120 may be driven by, e.g., gravity, a pump, or the like, or a combination thereof. Merely by way of example, a pump may be coupled to the inlet assembly 120 at 120El. More descriptions regarding the inlet assembly 120, or a portion thereof, may be found elsewhere in the present document. See also, e.g., FIGS. 2A, 2B, 3A through 4D, and 9A through 9J, and the description thereof.

The outlet assembly 130 including drainage pipes 130A and a horizontal outlet pipe 130B. The outlet assembly 130 may be in fluid communication with each of one or more of the blades 110 via an outlet (e.g., 240 as illustrated in FIGS. 2A and 2B) of the blade 110 and configured to guide the capture solution leaving the blade 110 via the outlet of the blade 110 to return to the capture solution storage device 150. The drainage pipes 130A and the outlet pipe 130B may form a conduit for guiding the capture solution exiting the blades 110 to return the capture solution storage device 150. For example, the drainage pipe 130A may include a plurality of outlet slits each of which may be fluidly coupled to the outlet of one blade segment of the blade 110 so that the capture solution exiting the blade 110 may flow to the drainage pipe 130A via the outlet of the blade segment and the fluidly coupled outlet slit. The capture solution leaving the blade segments of the respective blade 110 may flow to the drainage pipes 130A and return the capture solution storage device 150 through the outlet pipe 130B. The drainage pipes 130A may be substantially parallel to the rotation axis z. The outlet pipe 130B may be substantially perpendicular to the rotation axis z. It is understood that the orientation of any one of the drainage pipes 130A and the outlet pipe 130B is provided for illustration purposes and not intended to be limiting. Merely by way of example, the outlet pipe 130B may be perpendicular to or at an oblique angle with the rotation axis z. As another example, the drainage pipes 130A may be substantially parallel to each other, or at least two of the drainage pipes 130A may be at an oblique angle with each other. The flow of the capture solution within the outlet assembly 130 may be driven by, e.g., gravity, the centrifugal force on the capture solution exiting the blade segments of the blade 110, or the like, or a combination thereof. More descriptions regarding the outlet assembly 130, or a portion thereof, may be found elsewhere in the present document. See also, e.g., FIGS. 2A, 2B, and 5, and 9A through 9J, and the description thereof.

The rotation assembly 140 may be configured to cause the rotary motion of one or more of the blades 110 and/or blade segments. The rotation assembly 140 may include wind cups 140A and a balancing unit 140B. The wind cups 140A may be configured to harvest wind power and drive, using the harvested wind power, the blade segments and the blades 110 to undergo a rotary motion about a rotation axis z. The rotation axis z may substantially coincide with a center of the inlet pipe 120A (e.g., a long axis of the inlet pipe 120A). The wind cups 140A may be (directly or indirectly) attached to one or more of the blade segments of the blades 110 (e.g., along an edge or perimeter of the support base 210 of a blade segment) so that the wind power harvested by the wind cups 140A may drive the rotary motion of the blades 110. Merely by way of example, the wind cups 140A may be attached to the drainage pipes 130A. In some embodiments, the wind cups 140A may be fixedly attached to the drainage pipes 130A. In some embodiments, the wind cups 140A may be adjustably attached to the drainage pipes 130A such that the orientation of the wind cups 140A may be adjusted based on one or more factors including the ambient wind speed, a desired rotational rate of the blade segments and the blades 110, or the like, or a combination thereof. The amount or efficiency for harvesting wind power by the wind cups 140A (and therefore the magnitude of the driving force and the rotational rate of the rotary motion of the blade segments and the blades 110) may relate to the amount of area of the wind cups 140A exposed to wind. More descriptions regarding the rotation assembly 140, or a portion thereof, may be found elsewhere in the present document. See also, e.g., FIGS. 6 and 9A through 9J and the description thereof.

The balancing unit 140B may be configured to adjust or regulate a rotational rate of one or more of the blades 110. For example, the balancing unit 140B may be configured to adjust or regulate a rotational rate of one or more of the blades 110 such that the rotational rate remains below a rotational rate threshold. The balancing unit 140B may include a spring, a weight, a locking mechanism, or the like, or a combination thereof. In some embodiments, the balancing unit 140B may be configured to lock the blades 110 to prevent the rotary motion of the blades 110. For example, the blades 110 may be kept stationary in operation using the balancing unit 140B and air flows over the blades 110 and gets in contact with the capture solution during which carbon dioxide in the air is captured or extracted; the flow of the capture solution in the carbon dioxide capture device 100B may be driven by a pump. As another example, the blades 110 may be locked using the balancing unit 140B for transportation and/or setup.

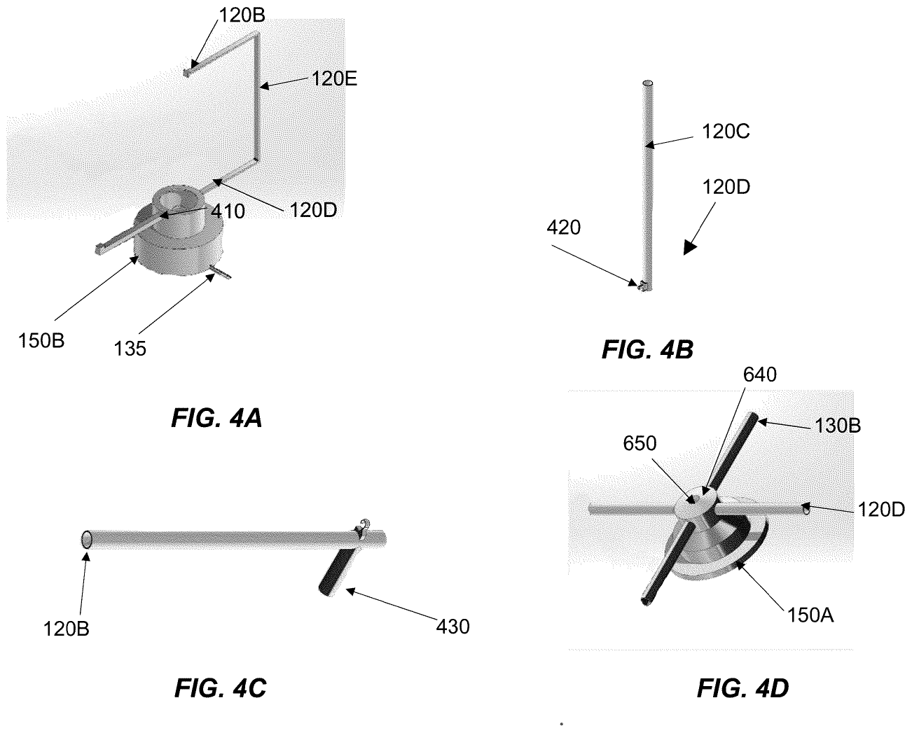

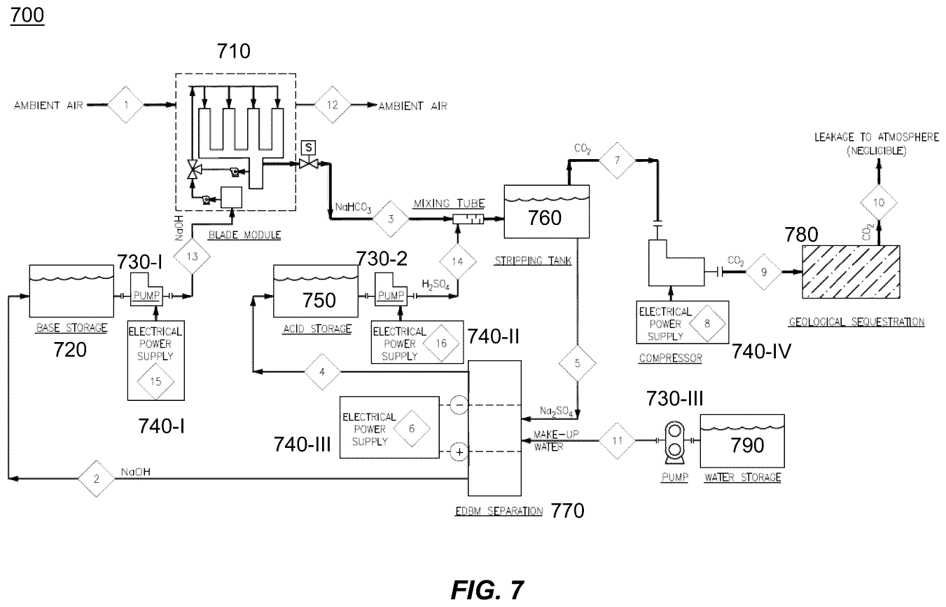

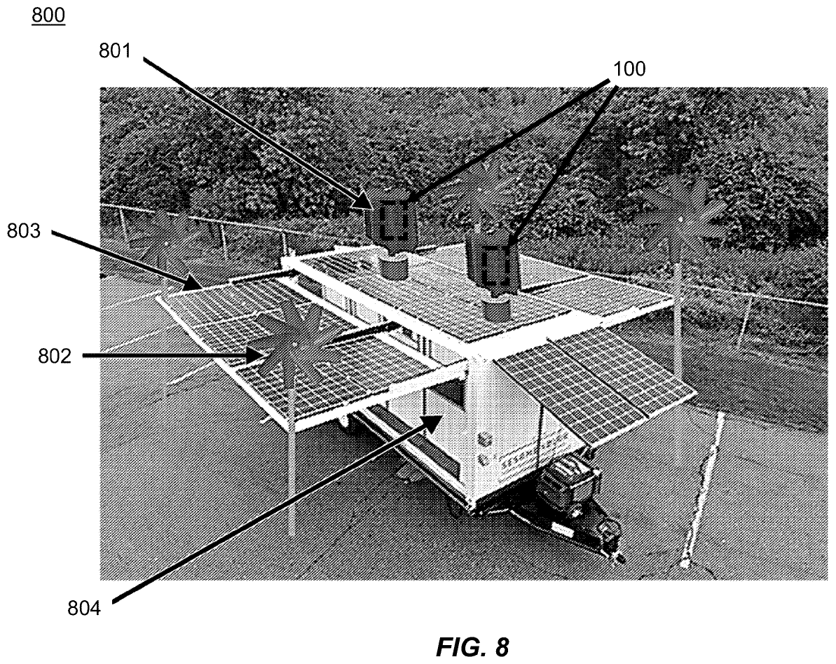

The capture solution storage device 150 may include a collector 150A, a base 150B, and a pillar 150C. The capture solution storage device 150 may be configured to store the capture solution to be fed to the blade segment(s) (and thereby to the blades 110) and collect the capture solution existing the blade segment(s) (and blades 110). The collector 150A may be configured to receive the capture solution exiting the blades 110 via the outlet assembly 130. The collector 150A may have the shape of a cylinder, a dome, or the like, or a combination thereof. Merely by way of example, the collector 150A may have the shape of a dome and accordingly be referred to as a dome collector. In some embodiments, the base 150B may include a tank for holding the capture solution in the carbon dioxide capture device 100B that is not flowing in the inlet assembly 120, the outlet assembly 130, or the blades 110. The inlet assembly 120 may feed the capture solution in the capture solution storage device 150 (e.g., the internal storage tank 410 as illustrated in FIG. 4A) to the blades 110. Merely by way of example, the base 150B may have the shape of a cylinder, a dome, or the like, or a combination thereof. The pillar 150C may be configured to support the inlet pipe 120A and receives the capture solution from the inlet pipe 120A. For example, at least a portion of the capture solution that flows into the inlet pipe 120A may flow to the blades 110 and the remaining capture solution may return to the capture solution storage device 150 through the inlet pipe 120A. The inlet pipe 120A may be coupled to the capture solution storage device 150 via a bearing 160B as illustrated in FIG. 1C. In some embodiments, the capture solution storage device 150 may include a channel 135 to allow the capture solution to leave and/or enter the capture solution storage device 150. For example, the channel 135 may be configured to establish a fluid communication between the capture solution storage device 150 and a regeneration device configured to process used capture solution such that the used capture solution may be renewed and return to the capture solution storage device 150 and/or to the inlet assembly 120 and/or to a stripping device configured to strip captured carbon dioxide. As another example, the channel 135 may allow fresh capture solution to be fed to the capture solution storage device 150. More descriptions regarding the capture solution storage device 150, or a portion thereof, may be found elsewhere in the present document. In some embodiments, the channel 135 may include a 3-way valve. See, e.g., FIGS. 4A through 4D and 7, and the description thereof.

Multiple components of the carbon dioxide capture device 100B may contact the capture solution, a product generated in the reaction between carbon dioxide and the capture device (e.g., a capture salt), etc. Examples of such components may include the pipes 120A through 120E of the inlet assembly 120, the pipes 130A and 130B of the outlet assembly 130, the blades 110, the capture solution storage device 150, etc. Any one of such component may include a material that is substantially inert to the caption solution and any product generated during the carbon dioxide capture (e.g., a capture salt) such that the component is corrosion resist with respect to the capture solution and the product. For example, the capture solution may include a metal hydroxide (e.g., NaOH, KOH), and the support base 210 may include a material that is substantially inert to the caption solution such that the support base 210 is corrosion resist with respect to the metal hydroxide solution; accordingly, the component may include a metal such as, for example, stainless steel, nickel, titanium, or the like, or an alloy thereof. In some embodiments, the component may include a polymer such as, for example, polytetrafluoroethylene (PTFE), plastic fiberglass, a plastic carbon composite, or the like, or a combination thereof. One or more components of the carbon dioxide capture device 100B may be mechanically coupled by way of, e.g., a screw, a clamp, welding, injection mold, or the like, or a combination thereof. Merely by way of example, the inlet pipe 120A and the inlet pipe 120B may be mechanically coupled using a screw, welding, or a butt joint, a coupling joint such as a Swagelok tube fitting. A mechanical or fluid coupling between two components, e.g., between the inlet pipe 120A and the inlet pipe 120B may be sealed using, e.g., a gasket, a sealant, etc., such that fluid (e.g., the capture solution) does not leak through the mechanical or fluid coupling.

At least one component of the carbon dioxide capture device 100B may be stationary in use. Example stationary components may include the carbon dioxide storage device 150, or a portion thereof (e.g., the internal storage tank 410 as illustrated in FIG. 4A). At least one component of the carbon dioxide capture device 100B may be configured to be moveable in use. Example stationary components may include the blades 110, the inlet assembly 120, the outlet assembly 130, the rotation assembly 140, or a portion thereof.

Merely by way of example, in some implementations of the carbon dioxide capture device 100B, to initiate an operation of the carbon dioxide capture device 100B, when the capture solution enters the inlet assembly 120 (e.g., the inlet pipe 120A) it is distributed through a first set of one or more blade segments on the top of the stack of blades 110 and then the capture solution exits the top blade segments (of the top blade 110) through the drainage pipe 130A, and return to the inlet assembly 120 (e.g., the inlet pipe 120A) and then the capture solution may pass through the first set of blade(s) 110 and in addition a second set of one or more blade segments and this process repeats until all the blade segments and blades 110 are filled with the capture solution, which continuously circulates through the carbon dioxide capture device 100B. It is understood that the example is provided for illustration purposes and not intended to be limiting. For example, to initiate an operation of the carbon dioxide capture device 100B, the capture solution may be first fed to the third set of blade segment(s) 110 at the bottom or in the middle of the blade stack of the carbon dioxide capture device 100B and gradually to the remaining blade segment(s) 110 in the blade stack.

FIGS. 2A through 2C illustrate schematics of an example blade according to some embodiments of the present document. FIGS. 2A and 2B illustrate an example blade segment 115. The blade segment 115 may include a support base 210, an air-permeable layer 220, an inlet 230, an outlet 240, and a plurality of surface features 250A through 250E. As illustrated in FIGS. 2A and 2B, the blade segment 115 or the support base 210 of the blade segment 115 may be substantially flat or planar. FIG. 2C illustrates an example embodiment of the blade segment 115 in which the blade segment 115 or the support base 210 of the blade segment 115 is curved. The support base 210 may be configured to provide a surface to allow the capture solution to flow across and contact between carbon dioxide-containing air and the capture solution. The support base 210 (including the surface features 250A through 250E on the support base 210 as described elsewhere in the present document) may include a material that is substantially inert to the caption solution and any product generated during the carbon dioxide capture (e.g., a capture salt) such that the support base 210 is corrosion resist with respect to the capture solution and the product. For example, the capture solution may include a metal hydroxide (e.g., NaOH, KOH), and the support base 210 may include a material that is substantially inert to the caption solution such that the support base 210 is corrosion resist with respect to the metal hydroxide solution. In some embodiments, the support base 210 may include a metal such as, for example, stainless steel, nickel, titanium, or the like, or an alloy thereof. In some embodiments, the support base 210 may include a polymer such as, for example, polytetrafluoroethylene (PTFE), plastic fiberglass, a plastic carbon composite, or the like, or a combination thereof.

The support base 210 may have the shape of a square, a rectangle, a circle, etc. The thickness of the support base 210 may be in a range from 1 mm to 50 mm, or from 2 mm to 30 mm, or from 2 mm to 20 mm, or below 50 mm, or below 40 mm, or below 30 mm, or below 20 mm, or at least 1 mm, or at least 2 mm, or at least 4 mm, or at least 5 mm, or at least 6 mm, or at least 8 mm, or at least 10 mm, or at least 15 mm. The surface area of the support base 210 (substantially equal to the surface area of the blade segment 115 as described elsewhere in the present document), e.g., for air-capture solution contact as described elsewhere in the present document, may be in a range of 100 cm² to 250,000 cm². For example, the surface area may be at least 100 cm², or at least 100 cm², or at least 200 cm², or at least 300 cm².

The support base 210 may include an inlet 230 and an outlet 240 configured to establish a fluid communication with the inlet assembly 120 and the outlet assembly 130, respectively. As described elsewhere in the present document, the capture solution may flow through the inlet assembly 120 to a blade segment 115 via the inlet 230 of the blade segment 115, and exit the blade segment 115 via the outlet 240 to the outlet assembly 130. The inlet 230 may be fluidly coupled to an inlet slit on the inlet pipe 120A. The inlet 230 may include an inlet aperture that is fluidly coupled to the inlet assembly 120. The inlet 230 may include an inlet tube that is fluidly coupled to the inlet assembly 120. The inlet tube may have a closed cross section having the shape of, e.g., a circle, an oval, or the like. The outlet 240 may be fluidly coupled to an outlet slit on the drainage pipe 130A. The outlet 240 may include an outlet aperture that is fluidly coupled to the outlet assembly 130. The outlet 240 may include an outlet tube that is fluidly coupled to the outlet assembly 130. The outlet tube may have a closed cross section having the shape of, e.g., a circle, an oval, or the like. In some embodiments, the inlet 230 and the outlet 240 of the blade segment 115 may oppose each other. For example, the support base 210 of the blade segment 115 may have the shape of a polygon (e.g., a square, a rectangle, or another type of polygon), and the inlet 230 and the outlet 240 of the blade segment 115 may be positioned on opposite corners or vertexes of the support base 210 of the blade segment 115. In such embodiments, the drainage pipes 130A fluidly coupled to a blade segment 115 via the outlet 240 may be located at a corner (or vertex) of the support base 210 of the blade segment 115, and the wind cups 140A may be attached to the drainage pipes 130A and therefore also located at or in a vicinity of the corner or vertex of the support base 210, respectively. A line 270 linking the inlet 230 and the outlet 240 may constitute a diagonal of the support base 210. As another example, the support base 210 of the blade segment 115 may have the shape of a circle, and the inlet 230 and the outlet 240 of the blade segment 115 may be positioned substantially along a diameter of the support base 210 of the blade segment 115. In such embodiments, the drainage pipes 130A fluidly coupled to the blade segments 115 via the outlets 240 may be located at the corners (or vertexes) of the support base, and the wind cups 140A may be attached to the drainage pipes 130A and therefore also located at or in a vicinity of the perimeter of the support base 210, respectively.

The support base 210 may include a brace 260. The brace 260 may be configured to enhance the mechanical strength of the support base 210, and/or facilitate the joining of the support base 210 with the air-permeable layer 220. The brace 260 may define edges of the support base 210 including, e.g., a first edge 280A and a second edge 280B. Reinforcing struts 290 may be positioned within the brace 260 to provide additional mechanical support for the brace 260 and/or the support base 210.

The support base 210 and the air-permeable layer 220 may collectively form a gap to allow the capture solution to flow through between the inlet 230 and the outlet 240. In some embodiments, the height of the gap may be between 0.1 mm to 3 mm. The heights of gaps of at least two of the blade segments may be the same. The heights of gaps of at least two of the blade segments may be different. For example, the air-permeable layer 220 and the support base 210 may be joined along a perimeter of the support base 210 to prevent leakage of the capture solution from the gap along the perimeter. The air-permeable layer 220 and the support base 210 may be joined by the brace 260, welding, fusion, an adhesive, or the like, or a combination thereof. The joint between the air-permeable layer 220 and the support base 210 may be impermeable to the capture solution so as to prevent leakage of the capture solution from the gap via the joint. In some embodiments, the joint may contact the capture solution, a product generated in the capture reaction (e.g., a capture salt), etc. The joint may include a material or be configured to be inert or corrosion resistant to the capture solution or such a product. For example, the joint is formed by an adhesive that is be inert or corrosion resistant to the capture solution or a capture salt. As another example, the joint is formed by the brace 260 that clamps the support base 210 and the air-permeable layer 220 together such that the capture solution or a capture salt does not contact the brace 260; accordingly, the brace 260 is protected from corrosion by the capture solution or the capture salt by way of non-contact. The joint may occupy a small surface are of the support base 210 such that the surface area of the gap available for the air-capture solution contact may be substantially equal to the surface area of the support base 210.

In some embodiments, the support base 210 may have a first surface and a second surface that is opposite the first surface; the support base 210 and a first air-permeable layer 220 may collectively form a first gap between the first surface of the support base 210 and the air-permeable layer 220, and the support base 210 and a second air-permeable layer 220 may collectively form a second gap between the second surface of the support base 210 and the second air-permeable layer 220. The capture solution may flow across the blade segment 115 through the first gap and the second gap. When the carbon dioxide capture device 100 is positioned such that the first surface of the support base 210 faces upward and the second surface of the support base 210 faces the ground, the capture solution flowing through the first gap may be supported by the first surface against gravity, and the capture solution flowing through the second gap may be supported by the air-permeable layer 220 against gravity. In some embodiments, the height of the first gap or the second gap may be between 0.1 mm and 3 mm, or between 0.2 mm and 3 mm. The height of the first gap may be the same as or different from the second gap.

The air-permeable layer 220 may be configured to allow air to enter the gap and contact the capture solution such that carbon dioxide in the air may be captured or extracted by reacting with the capture solution while the capture solution flows through the gap. The air-permeable layer 220 may be substantially impermeable to the capture solution so that the capture solution does not leak through the air-permeable layer 220. In some embodiments, the air-permeable layer 220 may be hydrophobic to facilitate the flow of the capture solution through the gap. The air-permeable layer 220 may include a porous polymer. In some embodiments, the air-permeable layer 220 may include a porous polymer having pores whose pore sizes are between 1 and 20 micrometers, or between 1 and 10 micrometers, etc. For example, the air-permeable layer 220 may include porous polyvinly fluoride (PVDF), polytetrafluoroethylene (ePTFE), and expanded polytetrafluoroethylene (ePTFE). For example, the pores with sizes between 1micrometer and 10 micrometers and a void volume in a range of 40-90%. At least some of the pores may be closed (e.g., circular). At least some of the pores may be interpenetrating with each other. The thickness of the air-permeably layer 220 can vary from about 5 μm to 150 μm. The air-permeably layer 220 can further include one or more layers (that may provide mechanical support) such as polypropylene fibers, Polysulfone, Nylon fibers, a polymer, or a metal mesh. Examples of the membrane materials include brands like GORE-TEX, ProTech, POLYFLON PTFE, etc.

The flow of the capture solution from the inlet 230 to the outlet 240 of the blade segment 115 may be driven by a rotary motion of the blade segment 115 (or interconnected blade segments of a blade), a pressure difference between the inlet 230 and the outlet 240 caused by a pump, or the like, or a combination thereof. The carbon dioxide capture may occur when the carbon dioxide in the air in contact with the capture solution reacts with the capture solution while the capture solution flows through the gap in the blade segment 115. The carbon dioxide capture may be improved by improving the contact area and/or contact time of the air-capture solution contact. In some embodiments, the support base 210 may include the plurality of the surface features 250A through 250E configured to cause or facilitate the capture solution to distribute on the support base 210 while the capture solution flows through the gap. For example, the plurality of the surface features 250A through 250E may be arranged such that the capture solution to distribute substantially evenly on the support base 210 while the capture solution flows through the gap. In some embodiments, the plurality of surface features 250A through 250E may include a first ridge or wall and a second ridge or wall that are spaced apart from and unparallel to each other. In some embodiments, the support base 210 may have a first edge (e.g., 280A) and a second edge (e.g., 280B) that are at an angle with each other, and the plurality of surface features 250A through 250E may include at least one of a first ridge or wall of a first group that is substantially parallel to the first edge (e.g., 250A), a second ridge or wall of a second group that is substantially parallel to the second edge (e.g., 250B), a third ridge or wall of a third group that is substantially perpendicular to the diagonal 270 (e.g., 250D), a fourth ridge or wall of a fourth group that is at an oblique angle with the first edge or the second edge (e.g., 250D), or a fifth ridge or wall of a fifth group that has a curved-shape (e.g., 250E), or the like, or a combination thereof. In some embodiments, the plurality of surface features 250A through 250E may include at least one of a ridge or wall depressed toward the capture solution storage device 150 or a ridge or wall projecting away from the capture solution storage device 150. In some embodiments, the support base 210 may include a plurality of channels arranged between the plurality of surface features 250A through 250E through which the capture solution flows. In some embodiments, the plurality of surface features 250A through 250E may be positioned within the perimeter of the support base 210 (e.g., the perimeter of the support base 210 defined by the brace 260). In some embodiments, the plurality of the surface features 250A through 250E may improve the mechanical property (e.g., strength) of the support base 210.

The arrangement of the plurality of surface features (e.g., 250A through 250E) may be adjusted or configured to adjust the flow of the capture solution on the blade segment 115, which in turn may adjust or improve the air-capture solution contact and carbon dioxide capture that occurs during the flow. The flow of the capture solution on the blade segment 115 may be simulated, providing guidance in selecting or optimizing the arrangement of the plurality of surface features, in combination with one or more other parameters that may impact the flow. Examples of such parameters may include the rotational rate of the blade segment 115, the flow rate of the capture solution entering the blade segment 115 via the inlet 230, the properties (e.g., viscosity) of the capture solution, or the like, or a combination thereof.

FIGS. 2D through 2H illustrate results of example simulations of a fluid flow over a surface with surface features performed using FLUENT according to some embodiments of the present document. The flow rate of the capture solution entering the blade segment 115 is assumed to be 7 kg/min. The viscosity and density of water can be used to approximate the properties of the capture solution. The support base 210 as used in the simulation is stainless steel. The rotary motion of the blade segment 115 used in the simulations are 1-2 rad/s with a radius of 0.65 m (equivalent to 2.34-4.68 kph) or zero. FIGS. 2D through 2H illustrate the simulated flow corresponding to different arrangements of the surface features in which the numbers (or counts) and positions of the surface features are different. The arrows in FIGS. 2D through 2H indicate the velocity vectors of the simulated capture solution flows. As illustrated in FIGS. 2D through 2H, the simulated flow is from the inlet 230 to the outlet 240. Different arrangements of the surface features may affect the flow pattern on the blade segment 115. Generally speaking, the results of the simulations suggest that the fluid velocity close to the inlet 230 is lower than the fluid velocity close to the outlet 240 (due at least in part to the centrifugal force from the rotary motion of the blade) and that the fluid velocity close to an orifice of a channel (e.g., region A in FIG. 2H) formed by the surface features may be higher than the fluid velocity in a region farther away from the orifice. The scale bar indicates the correspondence between the magnitude of the fluid velocity (in the range of 3.69×10⁻⁰² and 5.18×10⁻⁰¹ m/s) and the color (or grey scale). When a rotational force is applied (e.g., by a rotary motion of the blade or blade segment, the liquid path may become a curvier curve closer to the rotation axis. When the rotary motion of the blade segments or blades are turned on or off, the initial movement of the capture solution may need to be taken into consideration.

Additionally or alternatively, the air-capture solution contact may relate to the wind speed or the velocity of air. Merely by way of example, the wind speed or velocity of the air may be in a range 3-15 kph.

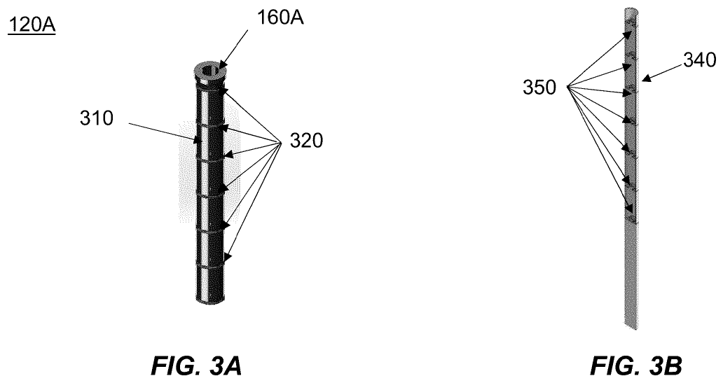

FIGS. 3A and 3B illustrate an example inlet pipe and its partial cross section according to some embodiments of the present document. The example of the inlet pipe 120A may include a column 310 on which there are inlet slits 320. Each of one or more of the plurality of inlet slits 320 may be fluidly coupled to the inlet 230 of a blade (e.g., one or multiple blade segment(s) 115 and/or the blade segment(s) 115B). The inlet pipe 120A may be configured to be fluidly coupled to a stack of blades (e.g., blade segment(s) 115, 115B) via the multiple inlet slits 320. In some embodiments, an inlet slit 320 may be a continuous opening to allow the capture solution to flow to the blades 110 (e.g., blade segment(s) 115, 115B) via the individual inlets of the blades/blade segments. In some embodiments, an inlet slit 320 may include multiple separate orifices each of which may correspond or be fluidly coupled to one of the inlets of the blades 110 (e.g., blade segment(s) 115, 115B).

Merely by way of example, each of one or more of the inlet slits 320 may be configured to have an interface to facilitate the fluid coupling to the inlet 230 of a blade 110. In some embodiments, such an interface of an inlet slit 320 may have an angle in a range between, e.g., 45 degrees to 90 degrees with respect to the blade 110 to which the inlet slit 320 is fluidly coupled. Merely by way of example, the interface of an inlet slit 320 may be tiled such that the portion of the interface connected or close to the inlet pipe 120A may be higher than the portion of interface extending away from the inlet pipe 120A and closer to the inlet 230 of the blade 110 such that the capture solution may flow from the inlet pipe 120A to the blade 110 via the interface and the inlet 230 driven at least in part by gravity. In some embodiments, the fluidly coupling between an inlet slit 320 and the inlet 230 of a blade 110 may include or be achieved/facilitated by way of a seal, a gasket, a screw.

On one end of the column 310 may include the bearing 160A. In some embodiments, inside the bearing 160A may exist another bearing configured to couple the inlet pipe 120A to the rotational components including the blade 110 (e.g., blade segments 115, 115B), thereby allowing coupling between rotating components (the blade segments 115, blade segments 115B, the inlet pipe 120A) and non-rotating (or stationary) components (e.g., the capture solution storage device 150, the inlet assembly 120, or a portion thereof). In some embodiments, the inlet pipe 120A may include another pipe 340 inside the column 310. As an example, the space between the pipe 340 and the inner surface of the column 310 may be filled with, e.g., an additive to create a seamless connection between the two so that the two can rotate simultaneously while allowing the capture solution flowing in the pipe 340 to a blade (e.g., blade segment(s) 115 or 115B). The additive may include, e.g., Teflon. As another example, the pipe 340 and the column 310 may be fused as an integral piece by way of injection molding. As a further example, the pipe 340 and the column 310 may be welded together. The pipe 340 may include pressure regulators 350 configured to regulate backpressure in a vicinity of the inlet slits 320. Merely by way of example, the pressure regulators 350 may include baffles. In some embodiments, in order to regulate backpressure, different inlet slits 320 may have different sizes for the capture solution to exit. For example, the inlet slits 320 may have decreased sizes along a descending direction (negative z direction) so as to force the capture solution out of the inlet pipe 120A through the inlet slits 320, instead of flowing to the bottom of the inlet pipe 120A and retuning the capture solution storage device 150. The pipe 340 may be coupled to a bearing that is housed within the capture solution storage device 150.

FIGS. 4A through 4D illustrate example inlet/outlet pipes and an example capture solution storage device according to some embodiments of the present document. FIG. 4A illustrates an example base 150B and the inlet pipe 120D that is fluidly coupled to the base 150B. The base 150B may include an internal storage tank 410 configured to store the capture solution (e.g., the portion in the carbon dioxide capture device 100B that is not in the inlet assembly 120, the outlet assembly 130, or flowing through the blade segments at any specific time point). The volume or capacity of the internal storage tank 410 may be larger than the total amount of the capture solution in the inlet assembly 120, the outlet assembly 130, and in the blades 110 (e.g., blade segments 115, blade segments 115B) 110 of the carbon dioxide capture device 100B so that the internal storage tank 410 can hold all the capture solution when the carbon dioxide capture device 100B during setup, storage, or transportation. Merely by way of example, the total volume that can be held in the inlet assembly 120, the outlet assembly 130, and in the blades 110 (e.g., blade segments 115, blade segments 115B) is 100 liters, the volume or capacity of the internal storage tank 410 may be at least 120 liters, or at least 150 liters. Merely by way of example, the internal storage tank 410 may have the shape of a cylinder whose diameter may be in a range from 0.5 cm to 10 cm.

As illustrated, the inlet pipe 120D may be fluidly coupled to the inlet pipes 120E and 120B. The base 150B may include the channel 135 to facilitate a fluid communication between the capture solution storage device 150 and another device (e.g., a regeneration device, a capture solution tank that is fluidly coupled to a pump for pumping the capture solution to the inlet assembly 120). The channel 135 may be located close to the bottom of the base 150B to take advantage of the driving force from gravity. As illustrated in FIG. 4B, the inlet pipes 120C and 120D may be coupled by welding or using a screw 420. Merely by way of example, the inlet pipe 120C may have an opening that is operably connected to a pump indirectly that is configured to pump the capture solution from the internal storage tank 410 or from a regeneration device to the blade 110 (e.g., blade segments 115, blade segments 115B) via the inlet assembly 120. The inlet pipe 120A may be configured to provide support to the rotational components. In some embodiments, a hook 430 may be coupled to the inlet pipe 120B to provide stability during use or transportation.

FIG. 4D illustrates an example collector 150A according to some embodiments of the present disclosure. As illustrated, the collector 150A may have the shape of approximately a dome. The collector 150A may be configured as a cover for the base 150B so that foreign matters (e.g., dust, debris) do not get into the inside of the base 150B, including the internal storage tank 410 and that the capture solution, or any capture product, does not spill out or evaporate. The collector 150A may include a bearing housing 640 where one or more bearings (e.g., 160B) may be accommodated. The bearing housing 640 may be located at a center of the internal storage tank 410 and act as the rotation axis z for the rotating components in the carbon dioxide capture device 100B.

The inlet assembly 120 may be fluidly coupled to the capture solution storage device 150 at the collector 150A. As illustrated in FIG. 4D, the inlet pipe 120D of the inlet assembly 120 may be fluidly coupled to the collector 150A at, e.g., a top portion of the collector 150A, via one or more openings on the collector 150A. As another example, the collector 150A may have an opening 650 at a center. The inlet pipe 120A (e.g., at least one of the column 310 or the pipe 340) may pass through the opening 650 to reach the internal storage tank 410 to establish a fluid communication and/or to be connected to the pillar 150C to attain mechanical support. The outlet assembly 130 may be fluidly coupled to the capture solution storage device 150 at the collector 150A. As illustrated in FIG. 4D, the outlet pipe 130B of the outlet assembly 130 may be fluidly coupled to the collector 150A at, e.g., a top portion of the collector 150A, via one or more openings on the collector 150A. In some embodiments, the inlet pipe 120B and the outlet pipe 130B may be staggered at different heights such that the inlet pipe 120B and the outlet pipe 130B are fluidly coupled to the capture solution storage device 150 separately and not in direct fluid communication with each other. Merely by way of example, the collector 150A may include four or eight openings to allow the inlet pipe(s) 120B and the outlet pipe(s) 130B to penetrate and establish a fluid communication with the capture solution storage device 150.

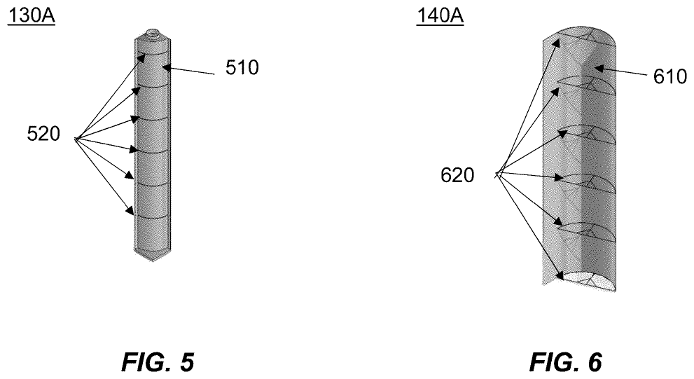

FIG. 5 illustrates an example outlet pipe according to some embodiments of the present document. The drainage pipe 130A may include a column 510. The column 510 may include a plurality of outlet slits 520. Each of one or more of the plurality of outlet slits 520 may be fluidly coupled to the outlet 240 of a blade (e.g., blade segment 115 or 115B). The drainage pipe 130A may be configured to be fluidly coupled to a stack of blades (e.g., blade segments 115, blade segments 115B) via the plurality of outlet slits 520. Merely by way of example, each of one or more of the plurality of outlet slits 520 may be configured to have an interface to facilitate the fluid coupling to the outlet 240 of a blade (e.g., blade segment 115, blade segment 115B). In some embodiments, such an interface of an outlet slit 520 may have an angle in a range between, e.g., 45 degrees to 90 degrees with respect to the blade (e.g., blade segment 115, blade segment 115B) to which the outlet slit 520 is fluidly coupled. Merely by way of example, the interface of an outlet slit 520 may be tiled such that the portion of the interface connected or close to the drainage pipe 130A may be lower than the portion of interface extending away from the drainage pipe 130A and closer to the outlet 240 of the blade (e.g., blade segment 115, blade segment 115B) such that the capture solution may flow from the blade (e.g., blade segment 115, blade segment 115B) via the outlet 240 to the drainage pipe 130A via the interface driven at least in part by gravity. In some embodiments, the fluidly coupling between an outlet slit 520 and the outlet 240 of a blade (e.g., blade segment 115, blade segment 115B) may include or be achieved/facilitated by way of a seal, a gasket, a screw. The drainage pipe 130A may be fluidly coupled to the outlet pipe 130B as illustrated in, e.g., FIG. 1C. In some embodiments, the diameter of a drainage pipe 130A may be at least twice the diameter of the inlet pipe 120A.

FIG. 6 illustrates an example wind cup according to some embodiments of the present document. The wind cup 140A may include a cup body 610. The cup body 610 may be configured to facilitate wind power harvest. For example, the cross section of the cup body 610 may have the shape of a portion of a circle (e.g., semi-circle). In some embodiments, the cup body 610 may include a sheet of material that has a small thickness to avoid a high mass. In some embodiments, the wind cup 140A may include a plurality of trusses 620 to provide mechanical strength of the wind cup 140A.

In some embodiments, the capture solution suitable for the carbon dioxide capture device 100 may include a basic solution. Examples of the capture solution may include a metal hydroxide solution, e.g., a sodium hydroxide solution, a potassium hydroxide solution, etc. Carbon dioxide in the air in contact with the capture solution may be captured or extracted from the air upon reaction with the capture solution that produces a salt (or referred to as a capture salt) including, e.g., a sodium carbonate, a potassium, or a sodium bicarbonate. The capture salt may resolve in the capture solution. The reaction may proceed while the capture solution flows on the blade(s) (e.g., blade segment(s) 115, blade segment(s) 115B) through the gap(s). The reaction may proceed at room temperature, and therefore obliviating the need to provide heating or cooling for the reaction to proceed and lower the energy needed for the carbon dioxide capture. The capture solution may be re-used for capturing carbon dioxide as described elsewhere in the present document until a regeneration condition is satisfied. An example of the regeneration condition is that the pH value of the capture solution reaches or exceeds a pH threshold. If the regeneration condition is satisfied, the used capture solution may be conveyed to a regeneration device as disclosed elsewhere in the present document to be renewed so as to become suitable for re-use. Affluent air (or referred to as post-capture air or carbon dioxide-lean air) exiting the carbon dioxide capture device 100 may have at least 5% less carbon dioxide than influent air (or referred to as pre-capture air or carbon dioxide-laden air) entering the carbon dioxide capture device 100. For example, the carbon dioxide capture device 100 may capture at least 5%, or at least 10%, or at least 20%, or at least 30%, or at least 40%, or at least 50%, or at least 60%, or at least 70%, or at least 80%, or more than 80% of carbon dioxide present in the influent air. The capture solution entering the blades 110 (e.g., blade segment(s) 115, 115B) may be referred to as a lean solvent, and the capture solution exiting the blades 110 (after capture reaction) may be referred to as a rich solvent.

FIG. 7 shows a diagram illustrating an example method for carbon dioxide capture and sequestration, labeled 700, according to some embodiments of the present technology. The method (or referred to as workflow or process) 700 includes intaking, into an example embodiment of the carbon dioxide capture device 100 (referred to in FIG. 7 as blade module 710), ambient air containing carbon dioxide (pre-capture air) to come in contact with capture solution in the blade module 710 (e.g., one or more blades 101 that include one or more blade segments) where at least a portion of the carbon dioxide in the ambient air may be captured, and the post-capture air with a reduced amount of carbon dioxide may leave the blade module 710 and return the ambient environment. The blade module 710 may include a plurality of blades (e.g., blades 110) configured to undergo a rotary motion to cause or facilitate the capture solution to distribute on the blades (e.g., flowing through gaps formed on the blades). The rotary motion of the blades may be driven, at least in part, by a rotation assembly (e.g., rotation assembly 140) including one or more wind cups (e.g., wind cups 140A). The capture solution (e.g., NaOH) may be fed to the blade module 710 from the base storage 720 (e.g., the capture solution storage device 150) driven by, e.g., pump 730-I. The operation of the pump 730-I may be driven by the electrical power supply 740-I. The capture solution may be re-used for carbon dioxide capture by the capture reaction as illustrated in formula (1) until a regeneration condition is met (e.g., its pH value reaching or exceeding a pH threshold). The base storage 720 may be re-filled with a fresh capture solution under one or more certain conditions (e.g., the volume of the capture solution in the base storage 720 is below a volume threshold). When the regeneration condition is met, the used capture solution containing the capture salt generated in the capture reaction may be conveyed to a carbon dioxide stripping tank 760 where the captured carbon dioxide may be stripped or separated from the used capture solution by reacting with a stripping solution (e.g., sulfuric acid (H₂SO₄)), resulting in separated carbon dioxide and a used stripping solution containing a second salt (or referred to as a stripping salt for brevity). The stripping reaction may be illustrated as formula (2). The stripping solution may be fed to the stripping tank 760 using a pump 730-II whose operation may be powered by electrical power supply 740-II. As illustrated, the used capture solution and the stripping solution may be mixed before entering the stripping tank 760. Carbon dioxide obtained by the stripping reaction in the stripping tank 760 may be sequestrated by way of, e.g., geological sequestration 780, or one or more other sequestration or techniques or applications. Merely by way of example, the carbon dioxide recovered at the stripping tank may be utilized using calcium hydroxide solution to make calcium carbonate precipitate. Carbon dioxide leakage from the sequestration may be negligible. The sequestration may involve a compressor whose operation may be powered by electrical power supply 740-IV. As another example, the recovered carbon dioxide may be used in fuel production, production of carbon, production of carbon nanofibers, production of diamonds, production of carbonate minerals, green house applications, food polishing applications, medical applications, carbonated drinks, making cyclic carbonates, cement and related applications, production of polycarbonates, production of graphite, application in algae growth, application in metal purification, production of dry ice, production of meat packaging, application in food storage, production of a solvent such as DMF. As a further example, the recovered carbon dioxide may be sequestered in other carbon dioxide sequestration such as being sequestered in abandoned oil and gas applications

The used stripping solution may be fed to a regeneration device including an EDBM separation tank 770 for processing (by way of a regeneration reaction as illustrated in formula (3) to generate a renewed capture solution and a renewed stripping solution. Water needed in the regeneration process may be pumped from water storage tank 790 to the EDBM separation tank 770 using a pump 730-III. The regeneration process may consume energy, provided by, e.g., electrical power supply 740-III. The renewed capture solution may be fed to the base storage 720 for further use in carbon dioxide capture. The renewed stripping solution may be fed to the acid storge 750 for further use in carbon dioxide stripping.

Part or all the power used in the example workflow 700 including electrical power supplies 740-I through 740-IV for operating the pumps 730-I through 730-III and the regeneration process may be derived from one or more natural sources including, e.g., wind power, solar power, or the like, or a combination thereof. As illustrated, the input of the example workflow 700 includes ambient air (or air with elevated carbon dioxide content from an industrial process or power generation process), the capture solution, the stripping solution, and water, and the output includes water, post-capture air with reduced carbon dioxide content, and negligible carbon dioxide leakage at the sequestration process. The capture solution and the stripping solution may be renewed with a high efficiency (by EDBM separation). Accordingly, the carbon dioxide capture by the example workflow 700 using a carbon dioxide capture device 100 as disclosed herein generates substantially no environmentally unfriendly substance with a low energy consumption.

FIG. 8 illustrates an example carbon dioxide capture system according to some embodiments of the present document. The example system 800 may include at least one of an air contactor 801 including an example embodiment of the carbon dioxide capture device 100 or 100B; a wind turbine 802; and/or a solar panel 803. In some embodiments, the air contactor 801 may be configured to direct and/or regulate air flow to the carbon dioxide capture device 100 (e.g., the carbon dioxide capture device 100B). The air contactor 801 may be placed near or on the top of a power generation unit (e.g., the solar panel 803 as illustrated in FIG. 8). For illustrated purposes and not intended to be limiting, four wind turbines 802 are illustrated in FIG. 8, and more or fewer wind turbine 802 may be included in the example system 800. The wind turbines 802 may be configured to generate electricity from wind power. The solar panel 803 may include a variety of solar cells and configured to generate electricity from solar power. The solar panel 803 may be placed above a trailer unit 804. The interior of trailer unit (804) may house, e.g., a power storage device (e.g., one or more batteries), solution tanks (e.g., a stripping tank, a stripping solution tank), and a regeneration device including an EDBM unit.

The example system 800 (or referred to as a direct air contact (DAC) system) may be modular and therefore convenient to scale up or down. For example, the example system 800 may be conveniently scaled by adding or removing one or more blades or blade segments to the air contactor 801, or adding or removing one or more air contractor 801. The example system 800 may be self-powered and stand-alone so that it may be transported to a desired location (e.g., in a backyard of a residential place, an industrial location where carbon dioxide is generated in an industrial process) for carbon dioxide capture. Further details of the air contactor 801, the wind turbine 802, and the solar panel 803 are described in PCT Patent Application Publication No. WO2022/192501A1, titled DIRECT AIR CAPTURE OF CO₂ USING LEAF-LIKE LAYERED CONTACTOR COUPLED WITH ELECTRO DIALYSIS BIPOLAR MEMBRANE REGENERATION, which is incorporated by reference as part of this disclosure for all purposes.

FIGS. 9A through 9J illustrate schematics of an example carbon dioxide capture device and components thereof according to some embodiments of the present document, including but not limited to the carbon dioxide capture device 100 and the carbon dioxide capture device 100B.

FIG. 9A illustrates a schematic of an example blade segment, labeled as 115B, according to some embodiments of the present document. The blade segment 115B may include a support base 910, an air-permeable layer 920, an inlet 930, an outlet 940, and a plurality of surface features 950A and 950B. The support base 910 may be the same as or similar to the support base 210, the description of which is applicable but not repeated here. The air-permeably layer 920 may be the same as or similar to the air-permeably layer 220, the description of which is applicable but not repeated here. The support base 910 and the air-permeable layer 920 may be joined around a perimeter 915 of the support base 910 for form a gap through which a capture solution may flow between the inlet 930 and the outlet 940. For example, the joint may be formed by raised edges at the perimeter of the support base 910 for an adhesive gasket 925 to adhere the air-permeable layer 920. Carbon dioxide-containing air may penetrate through the air-permeable layer 920 to get in contact with the capture solution so that the carbon oxide in the air may react with the capture solution. The joint may occupy a small surface are of the support base 910 such that the surface area of the gap available for the air-capture solution contact may be substantially equal to the surface area of the support base 910.

Merely by way of example, the raised edges along the perimeter of the support base 910 may be configured to facilitate the application of an adhesive seal to hold the air-permeable layer 920. In some embodiments, the height of the raised edges may be in a range of 0.5 mm to 2 mm. In some embodiments, the width of the raised edges (in a direction substantially perpendicular to the perimeter of the support base 910) may be in a range of 1 mm to 5 mm. An example adhesive or gasket to form the joint between the support base 910 and the air-permeable layer 920 may include a polyolefin block copolymer. The surface area of the blade segment 115B may be in a range between 10×10 inch to 250×250 inch depending on the need for carbon dioxide capture. The thickness of the blade segment 115 may be in a range of 0.1 cm to 0.5 cm. Compared to a thick blade or blade, a thin blade or blade may allow the accommodation of more surface area per unit volume of the carbon dioxide capture device (e.g., 100, 100B, 100C). The air-permeable layer 920 may include a PVDF membrane coated with polypropylene (PP) fibers. The air-permeable layer 920 may include pores whose sizes are in a range of 1 micrometer to 10 micrometers.

The inlet 930 may be the same as or similar to the inlet 230, the description of which is applicable but not repeated here. The outlet 940 may be the same as or similar to the outlet 240, the description of which is applicable but not repeated here. The outlet 940 may be fluidly connected with a liquid return tube 945. The liquid return tube 945 may be the same as or similar to the drainage pipe 130A, whose description is applicable but not repeated here.

The surface features 950A and 950B may be the same as or similar to the surface features 250A through 250E, the description of which is applicable but not repeated here. As illustrated, the surface feature 950A may include a ridge or wall that runs substantially along the diagonal of the support base 910; the surface features 950B may include multiple ridges or walls that are located on different sides of the surface feature 950A each of which may have the shape of a straight line or a curve. The surface features 950A and 950B may be configured to cause or facilitate the capture solution to flow (e.g., substantially evenly) from the inlet 930 to the outlet 940. Additionally or alternatively, the surface features 950A and 950B may be configured to prevent the air-permeable layer 920 from sagging such that the gap between the support base 910 and air-permeable layer 920 does not partially or entirely collapse. The surface features 950A and 950B may also improve the mechanical strength of the support base 910.

FIG. 9B illustrates an explored view of region C of FIG. 9A. As illustrated in FIG. 1B, the inlet 930 may be configured to facilitate a rotary coupling of the blade segment 115B with another component (e.g., inlet pipe 960A as illustrated in FIG. 9C). The blade segment 115B may undergo a rotary motion about a rotation axis z to cause or facilitate the capture solution to flow from the inlet 930 toward the outlet 940. Additionally or alternatively, the rotary motion may enhance the air flow over the surface of the blade segment 115B to facilitate the carbon dioxide capture. The rotary motion of the blade segment 115B may be driven, at least in part, by a rotation assembly (e.g., the rotation assembly 140, a rotation assembly including the wind cups 980).

FIG. 9C illustrates a schematic of two blades segment 115B sitting across each other. They are connected through a center column that may pump or drain the capture solution. These blades segment 115B may be configured to rotate in the direction of the wind to generate a centrifugal force. The Centrifugal force may allow for an easy drainage system. The capture solution may be forced toward the corner of a blade segment 115B where a drainage pipe sits. These blades segment 115B may be screwed upon the outer column which may allow for simple maintenance and revolution. The inner column may be stationary while the outer column may rotate with the blades segment 115B.

As illustrated in FIG. 9D, one blade segment 115B may be connected to the outer column at two points. There may be one hole at each side of the outer column that may allow the capture solution to enter the gap or space on the blade segment 115B.

As illustrated in FIG. 9E, the inner and outer columns may be configured to allow the capture solution to be pumped to the blades segment 115B. The levels within the inner column may be where the capture solution may flow. There may be holes on the outer column that may be at the same level as the levels in the inner column to allow the capture solution to exit the columns (corresponding to the inlet pipe 120A) and flow to the blade segment 115B. When the columns are flushed each hole corresponds to a blade that is fluidly connected to the outer column.

FIG. 9F illustrates a bottom view of an example blade assembly 110B including eight blades segment 115B. FIG. 9F shows both the inner column 960 that flows the capture solution up and the outer columns 970 that contains the drainage portion of capture solution. In the illustrated example, the blade assembly 110B may include eight blades segment 115B that constitute a staircase design. The drainage pipes 970 may be connected to the drainage system (corresponding to the outlet assembly 130).

FIG. 9G illustrates a partial bottom view of the blade assembly 110B. Each blade segment 115B has a drainage pipe 970 are on a corner (vertex) of the blade segment 115B. The drainage pipes 970 may be fluidly connected to the drainage system through couplers. The drainage pipes 970 may drain the capture solution containing captured carbon dioxide to an outer column (e.g., a pipe similar to the drainage pipe 130A or an outlet pipe 130B). Individual wind cups 980 may be connected to the drainage pipes 970, respectively, to pass air over the blades segment 115B.

As illustrated in FIG. 9H, the piping for the capture solution containing captured CO₂ may be placed at the bottom of the module's column (e.g., corresponding to the outlet pipe 130B). The capture solution exiting the blade segment 115B may then be drained into the outer column. These modules and columns are placed upon each other. So the holes at the top of the inner column (e.g., corresponding to the inlet pipe 120A) is for drainage into the outer column. The capture solution may be pumped toward the blade modules segment 115B from the inner column as indicated by one arrow pointing upward in FIG. 9H, the capture solution containing CO₂ from the blade modules segment 115B may be drained downward from the outer column, as indicated by the two arrows pointing downward in FIG. 9H, toward a capture solution storage device (e.g., a capture solution storage device 990 similar to the capture solution storage device 150).

FIG. 9I illustrates an example blade assembly 110B with multiple blades segment 115B and wind cups 980. As illustrated in FIG. 9J, multiple blade assembly 110B may be stacked for simple maintenance and increased surface areas for carbon dioxide capture per volume of a carbon dioxide capture device 100C. The carbon dioxide capture device 100C may further include the capture solution storage device 990 (e.g., same as or similar to the capture solution storage device 150). The example carbon dioxide capture device 100C may be incorporated into the system 800 and/or involved in 710 of the workflow 700.

The carbon dioxide capture device 100C may be configured to capture the CO₂ in the air. It may capture one ton of CO₂ with a 40 in×40 inch surface area provided by the blade assembly 110B, e.g., in one day. The carbon dioxide capture device 100C may be configured to use a sodium hydroxide solution that is pumped up into the inner column (e.g., inlet pipe 120A). The inner column may be configured to have levels that correspond to the outer column. These holes on the outer column may be fluidly connected to the blade assembly 110B for a simple screw-on and allow for the capture solution to enter the blade assembly 110B. The capture solution may be caused to pass through the blade assembly 110B and contact the air containing CO₂ through an air-permeable layer of the blade assembly 110B. The sodium hydroxide may react with CO₂ making the capture solution that contain a capture salt. The capture solution may flow toward a corner of the blade assembly 110B at least in part by a centripetal force and be drained via a drainage pipe. The blade assembly 110B may rotate with the wind making an easy drainage system. The surface features 950A and 950B in the space of each of one or more blade assembly 110B may be used for sloshing sodium hydroxide throughout all corners of the blade assembly 110B and for keeping the air-permeable layer from sagging. The capture solution may be drained to a drainage system that transports the solution containing CO₂ under the blade assembly 110B and into the outer column. The inner column has holes to pass the solution containing CO₂ from within and is then dripped into the outer column. The inner column may have the shape of a T. The outer column may be a cylinder. The inner and outer columns may be coupled upon each other while they are connected to blade segments to create a drainage system while the sodium hydroxide solution is pumped up.

The carbon dioxide capture device 100C can be built from plastic (PE, PP, PVC, cPVC, PTFE, EPDM, etc.) and stainless-steel components. The air-permeable layer can include fluoropolymer.

### EXAMPLES

The following examples are illustrative of several embodiments in accordance with the present technology. Other exemplary embodiments of the present technology may be presented prior to the following listed examples, or after the following listed examples.

In some embodiments in accordance with the present technology (example A1), a carbon dioxide capture device includes a blade configured to undergo a rotary motion around a rotation axis, the blade including a support base, an inlet, an outlet, and an air-permeable layer. In some embodiments, the support base and the air-permeable layer collectively form a gap through which a capture solution flows, driven by the rotary motion of the blade, between the inlet and the outlet, the support base includes a plurality of surface features configured to cause or facilitate the capture solution to distribute on the support base while the capture solution flows through the gap, the air-permeable layer is configured to allow air to enter the gap and contact the capture solution, and the capture solution is configured to extract carbon dioxide in the air while the capture solution flows through the gap. The carbon dioxide capture device of example A1 further includes a capture solution storage device configured to store the capture solution, an inlet assembly in fluid communication with the blade via the inlet of the blade and configured to feed the capture solution from the capture solution storage device to the blade through the inlet of the blade, an outlet assembly in fluid communication with the blade via the outlet of the blade and configured to guide the capture solution leaving the blade via the outlet of the blade to return to the capture solution storage device, and a rotation assembly configured to cause the rotary motion of the blade.

Example A2 includes the carbon dioxide capture device of example A1 or any of examples A1-A46, in which the plurality of surface features include a first ridge or wall and a second ridge or wall that are spaced apart from and unparallel to each other.

Example A3 includes the carbon dioxide capture device of example A1 or any of examples A1-A46, in which the support base has a first edge and a second edge that are at an angle with each other, and the plurality of surface features include at least one of a ridge or wall that is substantially parallel to the first edge or the second edge, a ridge or wall at an oblique angle with the first edge or the second edge, or a ridge or wall that has a curved-shape.

Example A4 includes the carbon dioxide capture device of example A1 or any of examples A1-A46, in which the plurality of surface features include at least one of a ridge or wall depressed toward the capture solution storage device or a ridge or wall projecting away from the capture solution storage device.

Example A5 includes the carbon dioxide capture device of example A1 or any of examples A1-A46, in which the rotation axis substantially coincides with a center of the blade.

Example A6 includes the carbon dioxide capture device of example A1 or any of examples A1-A46, in which the inlet assembly includes an inlet pipe that is fluidly coupled to the blade to feed the capture solution to the blade via the inlet of the blade.

Example A7 includes the carbon dioxide capture device of example A6 or any of examples A1-A46, in which the inlet pipe has an axis that substantially coincides with the rotation axis.

Example A8 includes the carbon dioxide capture device of example A6 or any of examples A1-A46, in which the blade is rotatably coupled to the inlet pipe via a bearing.

Example A9 includes the carbon dioxide capture device of example A1 or any of examples A1-A46, in which the outlet assembly includes a drainage pipe that is fluidly coupled to the blade to receive the capture solution exiting the blade via the outlet of the blade.

Example A10 includes the carbon dioxide capture device of example A1 or any of examples A1-A46, in which the blade has a surface area in a range of 100 cm² to 250,000 cm².

Example A11 includes the carbon dioxide capture device of example A1 or any of examples A1-A46, further including a plurality of blades each of which is configured to undergo a rotary motion around the rotation axis.

Example A12 includes the carbon dioxide capture device of example A11 or any of examples A1-A46, in which the rotary motions of the plurality of blades are substantially synchronized.

Example A13 includes the carbon dioxide capture device of example A11 or any of examples A1-A46, in which the rotation axis substantially coincides with a center of each of the plurality of blades.

Example A14 includes the carbon dioxide capture device of example A11 or any of examples A1-A46, in which each of the plurality of blades includes an inlet and an outlet and is in fluid communication with the inlet assembly and the outlet assembly via the inlet and the outlet, respectively.

Example A15 includes the carbon dioxide capture device of example A11 or any of examples A1-A46, in which at least some of the blades of the plurality of blades are substantially parallel to each other.

Example A16 includes the carbon dioxide capture device of example A11 or any of examples A1-A46, in which at least some of the blades of the plurality of blades are arranged substantially equidistantly along the rotation axis.

Example A17 includes the carbon dioxide capture device of example A11 or any of examples A1-A46, in which the inlet assembly includes an inlet pipe through which the capture solution flows from the capture solution storage device to the plurality of blades, the inlet pipe having a plurality of inlet slits each of which is fluidly coupled to an inlet of one of the plurality of blades.

Example A18 includes the carbon dioxide capture device of example A11 or any of examples A1-A46, in which the outlet assembly includes a drainage pipe through which the capture solution from the plurality of blades returns to the capture solution storage device, the drainage pipe having a plurality of outlet slits each of which is fluidly coupled to an outlet of one of the plurality of blades.

Example A19 includes the carbon dioxide capture device of example A1 or any of examples A1-A46, in which the air-permeable layer and the support base are joined along a perimeter of the support base to prevent leakage of the capture solution from the gap along the perimeter.

Example A20 includes the carbon dioxide capture device of example A19 or any of examples A1-A46, in which the air-permeable layer and the support base are joined using at least one of a brace or an adhesive.

Example A21 includes the carbon dioxide capture device of example A1 or any of examples A1-A46, in which the support base has a first surface and a second surface that is opposite the first surface, the support base and the air-permeable layer collectively form the gap between the first surface and the air-permeable layer, and the support base and a second air-permeable layer collectively form a second gap between the second surface and the second air-permeable layer, the capture solution flows, driven by the rotary motion of the blade, between the inlet and the outlet through the gap and the second gap.

Example A22 includes the carbon dioxide capture device of example A1 or any of examples A1-A46, in which the air-permeable layer is substantially impermeable to the capture solution.

Example A23 includes the carbon dioxide capture device of example A1 or any of examples A1-A46, in which the air-permeable layer includes a porous polymer.

Example A24 includes the carbon dioxide capture device of example A1 or any of examples A1-A46, in which the air-permeable layer includes polyvinly fluoride (PVDF), polytetrafluoroethylene (ePTFE), and expanded polytetrafluoroethylene (ePTFE).

Example A25 includes the carbon dioxide capture device of example A1 or any of examples A1-A46, in which the rotation assembly includes a wind cup positioned on an edge of the support base.

Example A26 includes the carbon dioxide capture device of example A1 or any of examples A1-A46, in which the support base has a plurality of vertexes, and the rotation assembly includes multiple wind cups each positioned at one of at least some of the plurality of vertexes.

Example A27 includes the carbon dioxide capture device of example A1 or any of examples A1-A46, in which the rotation assembly includes a balancing unit configured to maintain a rotational rate of the blade below a rotational rate threshold.

Example A28 includes the carbon dioxide capture device of example A27 or any of examples A1-A46, in which the balancing unit includes at least one of a spring or a weight.

Example A29 includes the carbon dioxide capture device of example A1 or any of examples A1-A46, in which the capture solution includes a basic solution.

Example A30 includes the carbon dioxide capture device of example A1 or any of examples A1-A46, in which the capture solution includes a metal hydroxide solution.

Example A31 includes the carbon dioxide capture device of example A1 or any of examples A1-A46, in which the capture solution includes a sodium hydroxide solution, and the carbon dioxide is extracted from the air upon reaction with the capture solution to produce a sodium carbonate solution or a sodium bicarbonate solution.

Example A32 includes the carbon dioxide capture device of example A1 or any of examples A1-A46, in which the carbon dioxide is extracted from the air upon reaction with the capture solution.

Example A33 includes the carbon dioxide capture device of example A1 or any of examples A1-A46, in which effluent air exiting the carbon dioxide capture device has at least 5% to 80% less carbon dioxide than influent air entering the carbon dioxide capture device.

Example A34 includes the carbon dioxide capture device of example A1 or any of examples A1-A46, in which the capture solution is reused for carbon dioxide capture in the carbon dioxide capture device until a pH value of the capture solution reaches or exceeds a pH threshold.

Example A35 includes the carbon dioxide capture device of example A1 or any of examples A1-A46, in which the carbon dioxide extraction occurs at a room temperature.

Example A36 includes the carbon dioxide capture device of example A1 or any of examples A1-A46, in which the support base includes a plurality of channels arranged between the plurality of surface features.

Example A37 includes the carbon dioxide capture device of example A1 or any of examples A1-A46, in which the support base includes a brace along a perimeter of the support base, and the plurality of surface features include ridges or wall positioned within the perimeter.

Example A38 includes the carbon dioxide capture device of example A1 or any of examples A1-A46, in which the blade has an inlet aperture as the inlet, the inlet aperture being fluidly coupled to the inlet assembly to guide the capture solution from the inlet assembly to the blade.

Example A39 includes the carbon dioxide capture device of example A1 or any of examples A1-A46, in which the inlet of the blade includes an inlet tube fluidly coupled to the inlet assembly to guide the capture solution from the inlet assembly to the blade.

Example A40 includes the carbon dioxide capture device of example A39 or any of examples A1-A46, in which the inlet tube has a closed cross section.

Example A41 includes the carbon dioxide capture device of example A1 or any of examples A1-A46, in which the blade has an outlet aperture as the outlet, the outlet aperture being fluidly coupled to the outlet assembly to guide the capture solution exiting the blade to the outlet assembly.

Example A42 includes the carbon dioxide capture device of example A1 or any of examples A1-A46, in which the outlet of the blade includes an outlet tube fluidly coupled to the outlet assembly to guide the capture solution exiting the blade to the outlet assembly.

Example A43 includes the carbon dioxide capture device of example A42 or any of examples A1-A46, in which the outlet tube has a closed cross section.

Example A44 includes the carbon dioxide capture device of example A1 or any of examples A1-A46, in which the carbon dioxide capture device includes a plurality of blades arranged in one or more blade segments.

Example A45 includes the carbon dioxide capture device of example A44 or any of examples A1-A46, in which the inlets of the blades of each of the one or more blade segments are located at a substantially same level along the rotation axis, and/or the outlets of the blades of each of the one or more blade segments are located at a substantially same level along the rotation axis.

Example A46 includes the carbon dioxide capture device of example A44 or any of examples A1-A45, in which the rotation axis substantially coincides with a center of each of at least some of the plurality of blade segments.

In some embodiments in accordance with the present technology (example B1), a direct-air-capture (DAC) system includes a carbon dioxide capture device. In some embodiments, the DAC system of example B1 includes a blade configured to undergo a rotary motion around a rotation axis, the blade including a support base, an inlet, an outlet, and an air-permeable layer, in which: the support base and the air-permeable layer collectively forming a gap through which a capture solution flows, driven by the rotary motion of the blade, between the inlet and the outlet, the support base includes a plurality of surface features configured to distribute the capture solution across the support base while the capture solution flows through the gap, the air-permeable layer is configured to allow air to enter the gap and contact the capture solution, and the capture solution is configured to extract carbon dioxide in the air by converting the carbon dioxide to an aqueous salt while the capture solution flows through the gap. The DAC system of example B1 further includes a capture solution storage device configured to store the capture solution, an inlet assembly in fluid communication with the blade via the inlet of the blade and configured to feed the capture solution from the capture solution storage device to the blade through the inlet of the blade, an outlet assembly in fluid communication with the blade via the outlet of the blade and configured to guide the capture solution leaving the blade via the outlet of the blade to return to the capture solution storage device, and a rotation assembly configured to cause the rotary motion of the blade, and an electrodialysis bipolar membrane (EDBM) device configured to regenerate a used capture solution and/or a used stripping solution.

Example B2 includes the DAC system of example B1 or any of examples B1-B11,further including a power assembly configured to provide power to operate the DAC system such that the DAC system is self-powered.

Example B3 includes the DAC system of example B2 or any of examples B1-B11, in which the power assembly includes at least one of a wind turbine configured to harvest wind power, a solar device configured to harvest solar power, or a power storage device.

Example B4 includes the DAC system of example B1 or any of examples B1-B11, further including at least one of: a carbon dioxide stripping device configured to strip the extracted carbon dioxide from the aqueous salt, a carbon dioxide sequestration pump configured to sequester the stripped carbon dioxide, and an acid tank configured to supply an acid solution to the carbon dioxide stripping device for stripping the extracted carbon dioxide.

Example B5 includes the DAC system of example B1 or any of examples B1-B11, in which the carbon dioxide capture device includes a plurality of blades.

Example B6 includes the DAC system of example B1 or any of examples B1-B11, further including a plurality of carbon dioxide capture devices.

Example B7 includes the DAC system of example B1 or any of examples B1-B11, in which the carbon dioxide extraction using the carbon dioxide capture device occurs at a room temperature.

Example B8 includes the DAC system of example B1 or any of examples B1-B11, in which the blade includes one or more features recited in any of examples A1-A46, C1-C4, D1-D3, and/or E1-E3.

Example B9 includes the DAC system of example B1 or any of examples B1-B11, in which the carbon dioxide capture device includes a plurality of blades arranged in blade segments.

Example B10 includes the DAC system of example B1 or any of examples B1-B11, in which the inlets of the blades of each of the blade segments are located at a substantially same level along the rotation axis, and/or the outlets of the blades of each of the blade segments are located at a substantially same level along the rotation axis.

Example B11 includes the DAC system of example B1 or any of examples B1-B10, in which the rotation axis substantially coincides with a center of each of at least some of the plurality of blade segments.

In some embodiments in accordance with the present technology (example C1), a direct-air-capture (DAC) system includes a plurality of carbon dioxide capture devices of any one of examples described herein, an electrodialysis bipolar membrane (EDBM) device configured to regenerate the capture solution that includes an aqueous salt generated by a reaction between the carbon dioxide extracted from the air by the plurality of carbon dioxide capture devices and the capture solution, and a power assembly configured to provide power to operate the DAC system such that the DAC system is self-powered.

Example C2 includes the DAC system of example C1 or any of examples C1-C4, in which the DAC system is configured to extract carbon dioxide from air at a room temperature.

Example C3 includes the DAC system of example C1 or any of examples C1-C4, in which the DAC system is configured to perform operations including capturing carbon dioxide at a location adjacent or remote from where the carbon dioxide is generated, and generating a carbon credit based on a net amount of the carbon dioxide captured.

Example C4 includes the DAC system of example C1 or any of examples C1-C3, wherein the blade includes one or more features recited in any of examples A1-A46, B1-B11, D1-D3, and/or E1-E3.

In some embodiments in accordance with the present technology (example D1), a blade includes a support base, an inlet, an outlet, and an air-permeable layer, in which the blade is configured to undergo a rotary motion around a rotation axis, the support base and the air-permeable layer collectively form a gap through which a capture solution flows, driven by the rotary motion of the blade, between the inlet and the outlet, the support base includes a plurality of surface features configured to cause or facilitate the capture solution to distribute on the support base while the capture solution flows through the gap, the air-permeable layer is configured to allow air to enter the gap and contact the capture solution, and the capture solution is configured to extract carbon dioxide in the air while the capture solution flows through the gap.

Example D2 includes the blade of example D1, in which the surface features are arranged so as to cause or facilitate the capture solution to distribute substantially evenly on the support base while the capture solution flows through the gap.

Example D3 includes the blade of example D1 or any of examples D1-D2, in which the blade includes one or more features recited in any of examples A1-A46, B1-B11, C1-C4, and/or E1-E3.

In some embodiments in accordance with the present technology (example E1), a blade includes a support base, an inlet, an outlet, and an air-permeable layer, in which the blade is configured to undergo a rotary motion around a rotation axis, the inlet and the outlet are positioned on opposite ends of a diagonal of the support base, the support base has a first edge and a second edge that are on opposite sides of the diagonal of the support base and at an angle with each other, the support base and the air-permeable layer collectively form a gap through which a capture solution flows, driven by the rotary motion of the blade, between the inlet and the outlet, the support base includes a plurality of surface features configured to cause or facilitate the capture solution to distribute on the support base while the capture solution flows through the gap, the plurality of surface features including a first group that includes at least one first ridge or wall substantially parallel to the first edge, a second group that includes at least one second ridge or wall substantially parallel to the second edge, a third group that includes at least one third ridge or wall substantially perpendicular to the diagonal of the support base, a fourth group that includes at least one fourth ridge or wall at an oblique angle with the first edge or the second edge, and a fifth group that includes at least one fifth ridge or wall of a substantially semi-circle shape, or a portion thereof, the air-permeable layer is configured to allow air to enter the gap and contact the capture solution, and the capture solution is configured to extract carbon dioxide in the air while the capture solution flows through the gap.

Example E2 includes the blade of example E1, in which the surface features are arranged so as to cause or facilitate the capture solution to distribute substantially evenly on the support base while the capture solution flows through the gap.

Example E3 includes the blade of example E1 or any of examples E1-E2, wherein the blade includes one or more features recited in any of examples A1-A46, B1-B11, C1-C4, and/or D1-D3.

In some embodiments in accordance with the present technology (example F1), a carbon dioxide capture device including the blade or a plurality of blade of any of examples D1-D3 and/or E1-E3.

### Conclusion

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present technology have been shown and described, it will be obvious to those skilled in the art that, based upon the teachings herein, changes and modifications may be made without departing from this technology and its broader aspects and, therefore, the appended claims are to encompass within their scope all such changes and modifications as are within the true spirit and scope of this technology. Furthermore, it is to be understood that the technology is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to technologies containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood with the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B, and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A carbon dioxide capture device comprising:
a blade configured to undergo a rotary motion around a rotation axis, the blade comprising a support base, an inlet, an outlet, and an air-permeable layer, wherein:
the support base and the air-permeable layer collectively forming a gap through which a capture solution flows, driven by the rotary motion of the blade, between the inlet and the outlet,
the support base comprises a plurality of surface features configured to facilitate the capture solution to distribute on the support base while the capture solution flows through the gap,
the air-permeable layer is configured to allow air to enter the gap and contact the capture solution, and
the capture solution is configured to extract carbon dioxide in the air while the capture solution flows through the gap,
a capture solution storage device configured to store the capture solution,
an inlet assembly in fluid communication with the blade via the inlet of the blade and configured to feed the capture solution from the capture solution storage device to the blade through the inlet of the blade,
an outlet assembly in fluid communication with the blade via the outlet of the blade and configured to guide the capture solution leaving the blade via the outlet of the blade to return to the capture solution storage device, and
a rotation assembly configured to cause the rotary motion of the blade.

2. The carbon dioxide capture device of claim 1, wherein the plurality of surface features comprise a first ridge or wall and a second ridge or wall that are spaced apart from and unparallel to each other.

3. The carbon dioxide capture device of claim 1, wherein:
the support base has a first edge and a second edge that are at an angle with each other, and
the plurality of surface features comprise at least one of a ridge or wall that is substantially parallel to the first edge or the second edge, a ridge or wall at an oblique angle with the first edge or the second edge, or a ridge or wall that has a curved-shape.

4. The carbon dioxide capture device of claim 1, wherein the plurality of surface features comprise at least one of a ridge or wall depressed toward the capture solution storage device or a ridge or wall projecting away from the capture solution storage device.

5. The carbon dioxide capture device of claim 1, wherein the rotation axis substantially coincides with a center of the blade, an edge of the blade, or a corner of the blade.

6. The carbon dioxide capture device of claim 1, wherein the inlet assembly comprises an inlet pipe that is fluidly coupled to the blade to feed the capture solution to the blade via the inlet of the blade.

7. The carbon dioxide capture device of claim 6, wherein the inlet pipe has an axis that substantially coincides with the rotation axis.

8. The carbon dioxide capture device of claim 6, wherein the blade is rotatably coupled to the inlet pipe via a bearing.

9. The carbon dioxide capture device of claim 1, wherein the outlet assembly comprises a drainage pipe that is fluidly coupled to the blade to receive the capture solution exiting the blade via the outlet of the blade.

10. The carbon dioxide capture device of claim 1, wherein the blade has a surface area in a range of 100 cm² to 250,000 cm².

11. The carbon dioxide capture device of claim 1, further comprising a plurality of blades separated by a distance in a vertical plane, each of which is configured to undergo a rotary motion around the rotation axis.

12. The carbon dioxide capture device of claim 11, wherein the rotary motions of the plurality of blades are substantially synchronized.

13. The carbon dioxide capture device of claim 11, wherein the rotation axis substantially coincides with a center of each of the plurality of blades.

14. The carbon dioxide capture device of claim 11, wherein each of the plurality of blades comprises an inlet and an outlet and is in fluid communication with the inlet assembly and the outlet assembly via the inlet and the outlet, respectively.

15. The carbon dioxide capture device of claim 11, wherein at least some of the blades of the plurality of blades comprise two or more blade segments that are substantially parallel to each other in a horizontal plane.

16. The carbon dioxide capture device of claim 11, wherein at least some of the blades of the plurality of blades are arranged substantially equidistantly along the rotation axis.

17. The carbon dioxide capture device of claim 11, wherein the inlet assembly comprises an inlet pipe through which the capture solution flows from the capture solution storage device to the plurality of blades, the inlet pipe having a plurality of inlet slits each of which is fluidly coupled to an inlet of one of the plurality of blades.

18. The carbon dioxide capture device of claim 11, wherein the outlet assembly comprises a drainage pipe through which the capture solution from the plurality of blades returns to the capture solution storage device, the drainage pipe having a plurality of outlet slits each of which is fluidly coupled to an outlet of one of the plurality of blades.

19. The carbon dioxide capture device of claim 1, wherein the air-permeable layer and the support base are joined along a perimeter of the support base to prevent leakage of the capture solution from the gap along the perimeter.

20. The carbon dioxide capture device of claim 19, wherein the air-permeable layer and the support base are joined using at least one of a brace or an adhesive.

21. The carbon dioxide capture device of claim 1, wherein:
the support base has a first surface and a second surface that is opposite the first surface,
the support base and the air-permeable layer collectively form the gap between the first surface and the air-permeable layer, and
the support base and a second air-permeable layer collectively form a second gap between the second surface and the second air-permeable layer,
the capture solution flows, driven by the rotary motion of the blade, between the inlet and the outlet through the gap and the second gap.

22. The carbon dioxide capture device of claim 1, wherein the air-permeable layer is substantially impermeable to the capture solution.

23. The carbon dioxide capture device of claim 1, wherein the air-permeable layer comprises a porous polymer.

24. The carbon dioxide capture device of claim 1, wherein the air-permeable layer comprises polyvinly fluoride (PVDF), polytetrafluoroethylene (ePTFE), and expanded polytetrafluoroethylene (ePTFE).

25. The carbon dioxide capture device of claim 1, wherein the rotation assembly comprises a wind cup positioned on an edge of the support base.

26. The carbon dioxide capture device of claim 1, wherein:
the support base has a plurality of vertexes, and
the rotation assembly comprises multiple wind cups each positioned at one of at least some of the plurality of vertexes.

27. The carbon dioxide capture device of claim 1, wherein the rotation assembly comprises a balancing unit configured to maintain a rotational rate of the blade below a rotational rate threshold.

28. The carbon dioxide capture device of claim 27, wherein the balancing unit comprises at least one of a spring or a weight.

29. The carbon dioxide capture device of claim 1, wherein the capture solution comprises a basic solution.

30. The carbon dioxide capture device of claim 1, wherein the capture solution comprises a metal hydroxide solution.

31. The carbon dioxide capture device of claim 1, wherein:
the capture solution comprises a sodium hydroxide solution, and
the carbon dioxide is extracted from the air upon reaction with the capture solution to produce a sodium carbonate solution or a sodium bicarbonate solution.

32. The carbon dioxide capture device of claim 1, wherein the carbon dioxide is extracted from the air upon reaction with the capture solution.

33. The carbon dioxide capture device of claim 1, wherein effluent air exiting the carbon dioxide capture device has at least 5% to 80% less carbon dioxide than influent air entering the carbon dioxide capture device.

34. The carbon dioxide capture device of claim 1, wherein the capture solution is reused for carbon dioxide capture in the carbon dioxide capture device until a pH value of the capture solution reaches or exceeds a pH threshold.

35. The carbon dioxide capture device of claim 1, wherein the carbon dioxide extraction occurs at a room temperature.

36. The carbon dioxide capture device of claim 1, wherein the support base comprises a plurality of channels arranged between the plurality of surface features.

37. The carbon dioxide capture device of claim 1, wherein:
the support base comprises a brace along a perimeter of the support base, and
the plurality of surface features comprise ridges or walls positioned within the perimeter.

38. The carbon dioxide capture device of claim 1, wherein the blade has an inlet aperture as the inlet, the inlet aperture being fluidly coupled to the inlet assembly to guide the capture solution from the inlet assembly to the blade.

39. The carbon dioxide capture device of claim 1, wherein the inlet of the blade comprises an inlet tube fluidly coupled to the inlet assembly to guide the capture solution from the inlet assembly to the blade.

40. The carbon dioxide capture device of claim 39, wherein the inlet tube has a closed cross section.

41. The carbon dioxide capture device of claim 1, wherein the blade has an outlet aperture as the outlet, the outlet aperture being fluidly coupled to the outlet assembly to guide the capture solution exiting the blade to the outlet assembly.

42. The carbon dioxide capture device of claim 1, wherein the outlet of the blade comprises an outlet tube fluidly coupled to the outlet assembly to guide the capture solution exiting the blade to the outlet assembly.

43. The carbon dioxide capture device of claim 42, wherein the outlet tube has a closed cross section.

44. The carbon dioxide capture device of claim 1, further comprising a plurality of blade segments.

45. The carbon dioxide capture device of claim 44, wherein:
the inlets of at least one blade segment are located at a substantially same level along the rotation axis, and/or
the outlets of the at least one blade segment are located at a substantially same level along the rotation axis.

46. The carbon dioxide capture device of claim 44, wherein the rotation axis substantially coincides with a center of each of at least some of the plurality of blade segments.

47. A direct-air-capture (DAC) system, comprising:
a carbon dioxide capture device comprising:
a blade configured to undergo a rotary motion around a rotation axis, the blade comprising a support base, an inlet, an outlet, and an air-permeable layer, wherein:
the support base and the air-permeable layer collectively forming a gap through which a capture solution flows, driven by the rotary motion of the blade, between the inlet and the outlet,
the support base comprises a plurality of surface features configured to distribute the capture solution across the support base while the capture solution flows through the gap,
the air-permeable layer is configured to allow air to enter the gap and contact the capture solution, and
the capture solution is configured to extract carbon dioxide in the air by converting the carbon dioxide to an aqueous salt while the capture solution flows through the gap,
a capture solution storage device configured to store the capture solution,
an inlet assembly in fluid communication with the blade via the inlet of the blade and configured to feed the capture solution from the capture solution storage device to the blade through the inlet of the blade,
an outlet assembly in fluid communication with the blade via the outlet of the blade and configured to guide the capture solution leaving the blade via the outlet of the blade to return to the capture solution storage device, and
a rotation assembly configured to cause the rotary motion of the blade, and
an electrodialysis bipolar membrane (EDBM) device configured to regenerate the capture solution that includes the aqueous salt.

48. The DAC system of claim 47, further comprising a power assembly configured to provide power to operate the DAC system such that the DAC system is self-powered.

49. The DAC system of claim 48, wherein the power assembly comprises at least one of a wind turbine configured to harvest wind power, a solar device configured to harvest solar power, or a power storage device.

50. The DAC system of claim 47, further comprising at least one of:
a carbon dioxide stripping device configured to strip the extracted carbon dioxide from the aqueous salt,
a carbon dioxide sequestration pump configured to sequester the stripped carbon dioxide, and
an acid tank configured to supply an acid solution to the carbon dioxide stripping device for stripping the extracted carbon dioxide.

51. The DAC system of claim 47, wherein the carbon dioxide capture device comprises a plurality of blades.

52. The DAC system of claim 47, further comprising a plurality of carbon dioxide capture devices.

53. The DAC system of claim 47, wherein the carbon dioxide extraction using the carbon dioxide capture device occurs at a room temperature.

54. The DAC system of claim 47, wherein the carbon dioxide capture device comprises a plurality of blades arranged in blade segments.

55. The DAC system of claim 54, wherein:
the inlets of blades of each of the blade segments are located at a substantially same level along the rotation axis, and/or
the outlets of blades of each of the blade segments are located at a substantially same level along the rotation axis.

56. The DAC system of claim 54, wherein the rotation axis substantially coincides with a center of each of at least some of the plurality of blade segments.

57. A direct-air-capture (DAC) system, comprising:
a plurality of carbon dioxide capture devices of any one of claims 1-46,
an electrodialysis bipolar membrane (EDBM) device configured to regenerate the capture solution that includes an aqueous salt generated by a reaction between the carbon dioxide extracted from the air by the plurality of carbon dioxide capture devices and the capture solution, and
a power assembly configured to provide power to operate the DAC system such that the DAC system is self-powered.

58. The DAC system of claim 57, wherein the DAC system is configured to extract carbon dioxide from air at a room temperature.

59. The DAC system of claim 57, wherein the DAC system is configured to perform operations including:
capturing carbon dioxide at a location adjacent or remote from where the carbon dioxide is generated, and
generating a carbon credit based on a net amount of the carbon dioxide captured.

60. A blade comprising a support base, an inlet, an outlet, and an air-permeable layer, wherein:
the blade is configured to undergo a rotary motion around a rotation axis,
the support base and the air-permeable layer collectively form a gap through which a capture solution flows, driven by the rotary motion of the blade, between the inlet and the outlet,
the support base comprises a plurality of surface features configured to facilitate the capture solution to distribute on the support base while the capture solution flows through the gap,
the air-permeable layer is configured to allow air to enter the gap and contact the capture solution, and
the capture solution is configured to extract carbon dioxide in the air while the capture solution flows through the gap.

61. The blade of claim 60, wherein the plurality of surface features are arranged so as to facilitate the capture solution to distribute substantially evenly on the support base while the capture solution flows through the gap.

62. A carbon dioxide capture device comprising the blade or a plurality of the blade of claim 60 or 61.

63. A blade, comprising: a support base, an inlet, an outlet, and an air-permeable layer, wherein:
the blade is configured to undergo a rotary motion around a rotation axis,
the inlet and the outlet are positioned on opposite ends of a diagonal of the support base,
the support base has a first edge and a second edge that are on opposite sides of the diagonal of the support base and at an angle with each other,
the support base and the air-permeable layer collectively form a gap through which a capture solution flows, driven by the rotary motion of the blade, between the inlet and the outlet,
the support base comprises a plurality of surface features configured to facilitate the capture solution to distribute on the support base while the capture solution flows through the gap, the plurality of surface features comprising a first group that includes at least one first ridge or wall substantially parallel to the first edge, a second group that includes at least one second ridge or wall substantially parallel to the second edge, a third group that includes at least one third ridge or wall substantially perpendicular to the diagonal of the support base, a fourth group that includes at least one fourth ridge or wall at an oblique angle with the first edge or the second edge, and a fifth group that includes at least one fifth ridge or wall of a substantially semi-circle shape, or a portion thereof,
the air-permeable layer is configured to allow air to enter the gap and contact the capture solution, and
the capture solution is configured to extract carbon dioxide in the air while the capture solution flows through the gap.

64. The blade of claim 63, wherein the plurality of surface features are arranged so as to facilitate the capture solution to distribute substantially evenly on the support base while the capture solution flows through the gap.

65. A carbon dioxide capture device comprising the blade or a plurality of the blade of claim 63 or 64.
